(19) United States
(12) Patent Application Publication
(10) Pub. No.: US 2020/0008122 A1
(43) Pub. Date: Jan. 2, 2020

(54) PREDICTIVE MAKE-BEFORE-BREAK CONNECTED VEHICLE CONNECTIVITY

(71) Applicant: Kymeta Corporation, Redmond, WA (US)

(72) Inventors: Ron RADKO, Kirkland, WA (US); Thomas FREEMAN, Mukilteo, WA (US); Paul KLASSEN, Newcastle, WA (US); Ryan STEVENSON, Woodinville, WA (US); Jung Sup KIM, Mukilteo, WA (US); Nicholas HARGREAVES, Spokane, WA (US); Jonas NICHOLSON, Preston, WA (US)

(21) Appl. No.: 16/455,447

(22) Filed: Jun. 27, 2019

Related U.S. Application Data
(60) Provisional application No. 62/692,488, filed on Jun. 29, 2018.

(51) Int. Cl. H04W 36/32; H04W 40/30; H04W 28/02; H04W 76/15; H04W 76/34; H04W 4/40

(52) U.S. Cl. CPC H04W 36/32; H04W 40/30; H04W 28/0226; H04W 28/0247; H04W 76/34; H04W 4/40; H04W 76/15

(57) ABSTRACT

A system and method for predictive make-before-break connected vehicle connectivity are described. In one embodiment, the method comprises receiving external information related to a route being taken by a vehicle containing an antenna for use in wireless communication; and proactively switching from a first communication connection to a second communication connection before reaching a location on the route that the vehicle is expected to pass at a future time and at which the first communication connection is expected to be unavailable.

### PRIORITY

The present patent application claims priority to and incorporates by reference the corresponding provisional patent applications No. 62/692,488, titled, “Predictive Make-Before-Break Connected Car Connectivity, including Handling of Discontinuities and Path-discernment Based on Data Types,” filed on Jun. 29, 2018.

### FIELD OF THE INVENTION

Embodiments of the present invention relate to the field of wireless communication; more particularly, embodiments of the present invention relate to proactively switching between wireless communication connections when one connection is going to be unavailable.

### BACKGROUND OF THE INVENTION

Make-before-break is a standard cellular concept based on cell strength; however, this is only an aspirational satellite concept based on satellite location. For satellite communication, a satellite terminal attempting to stay in communication with a constellation of nonstationary satellites can point to a given satellite only while that satellite is within the terminal's field of view. When the satellite leaves the field of view, the terminal must point to a different satellite that has recently entered the field of view. With only a single beam to point to any given satellite at any one time, the RF connection will be lost during the transition to a different satellite. That is, the satellite will have to break its connection with the satellite leaving its field of view so that it can make a connection with a new satellite that is entering or already in its field of view. This break-before-make connection results in a connectivity outage, caused by time for the antenna to switch pointing angles, time for the tracking algorithms to optimize the pointing on the new satellite, time for the modem to lock to the new carrier, and time for the network to re-establish end-to-end connection.

### SUMMARY OF THE INVENTION

A system and method for predictive make-before-break connected vehicle connectivity are described. In one embodiment, the method comprises receiving external information related to a route being taken by a vehicle containing an antenna for use in wireless communication; and proactively switching from a first communication connection to a second communication connection before reaching a location on the route that the vehicle is expected to pass at a future time and at which the first communication connection is expected to be unavailable.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIG. 1 is a block diagram of one embodiment of a vehicle communication system.

FIG. 2 is a block diagram of one embodiment of a connectivity engine.

FIG. 3 is a block diagram of one embodiment of portions of a data analyzer of a connectivity engine.

FIG. 4 is a flow diagram of one embodiment of a process for proactively switching communication connections used by a vehicle.

FIG. 5A illustrates one embodiment of a beam splitting antenna system.

FIG. 5B is a block diagram of an alternative beam splitting antenna system.

FIG. 6 illustrates the schematic of one embodiment of a cylindrically fed holographic radial aperture antenna.

FIG. 7 illustrates a perspective view of one row of antenna elements that includes a ground plane and a reconfigurable resonator layer.

FIG. 8A illustrates one embodiment of a tunable resonator/slot.

FIG. 8B illustrates a cross section view of one embodiment of a physical antenna aperture.

FIGS. 9A-D illustrate one embodiment of the different layers for creating the slotted array.

FIG. 10 illustrates a side view of one embodiment of a cylindrically fed antenna structure.

FIG. 11 illustrates another embodiment of the antenna system with an outgoing wave.

FIG. 12 illustrates one embodiment of the placement of matrix drive circuitry with respect to antenna elements.

FIG. 13 illustrates one embodiment of a TFT package.

FIG. 14 is a block diagram of one embodiment of a communication system having simultaneous transmit and receive paths.

### DETAILED DESCRIPTION

In the following description, numerous details are set forth to provide a more thorough explanation of the present invention. It will be apparent, however, to one skilled in the art, that the present invention may be practiced without these specific details. In other instances, well-known structures and devices are shown in block diagram form, rather than in detail, in order to avoid obscuring the present invention.

Embodiments of the invention include a method and apparatus for predicting or choosing which communication path is to be used to send data to and from a vehicle (e.g., car, truck, etc.). In one embodiment, the method and apparatus select among a plurality of paths and determine when to implement that selection. In one embodiment, the plurality of paths includes multiple satellite communication connections. These multiple communication connections may be made with the same satellite antenna through the use of different frequencies (e.g., two beams at different frequencies) or different carrier sizes (e.g., two beams with different carrier sizes). In another embodiment, the plurality of paths includes satellite and terrestrial communication paths. In one embodiment, the terrestrial communications are performed using terrestrial cellular communications (e.g., 5G, LTE, or other standard radio communications), while the satellite communications are performed using satellite 5G, GEO/LEO, HEO or other Non-Terrestrial Network (NTN) constellations, or other satellite communications.

In one embodiment, the selection among the plurality of communication paths is made proactively when a communication path currently being used is going to be unavailable in the future. In this case, by proactively switching to another communication path prior to losing communication with the communication path currently being used, embodiments described herein implement a make-before-break communication system. Thus, the techniques described herein enable seamless data connectivity when communication paths can become unavailable. In one embodiment, this make-before-break communication system is between terrestrial (e.g., cellular) and NTNs (e.g., satellite communication networks) and is based on predictive data analytics. In other embodiments, this make-before-break communication system is between one satellite connection via a LEO, MEO or GEO satellite network and another satellite connection via a LEO, MEO or GEO satellite network.

Embodiments of the present invention include a number of advantages. First, embodiments described herein implement a make-before-break concept in a communication system that uses satellite communication and exploits the terrestrial notion that roads are fixed and do not move. More specifically, in one embodiment, the roads and the available communication connectivity on those roads are mapped. In one embodiment, the information regarding available communication connectivity is obtained from the current vehicle and/or other vehicles using the road and their experiences with the communication connectivity of different forms of communication. With this mapping, the communication system knows where connectivity is to both the satellite and terrestrial networks, knows the quality of each of these communication types, and knows where communication with either type does not exist. With this knowledge, in one embodiment, the system compares, contrasts and then matches this coverage based on network performance and the data's requirements for cost, latency, security, quality of service (QoS), and bulk delivery. With the knowledge of the location of the vehicle, where it is likely to be going based on that vehicle's history and/or extrapolating likely destinations based on other information (e.g., crowd information), and current traffic, construction, weather, and foliage conditions, the system knows where a terrestrial system fails and where an NTN system does not, and vice versa. Based on this knowledge, in one embodiment, the system can make the connection to another network and continue the connection un-interrupted. In one embodiment, switching connections includes synchronizing an IP address used on one of the communication connections with the other so that the communication session is maintained across the two different communication connections.

In another embodiment, the system can switch connections with minimal interruption time. For example, there are non-dual beam handoff scenarios in which it is known that a beam, e.g., lose beam 1 on satellite 1, will be lost and that another beam, e.g. beam 2 on satellite 2, will be available, and the tracking information is used from the current attitude while tracking the first beam (beam 1) in order to have a highly accurate switch to the new beam (beam 2), thereby greatly reducing the search time to find the new beam. This will result in a fast handoff that could be viewed as nearly seamless from a user standpoint, even though the connection is broken before a new one is made.

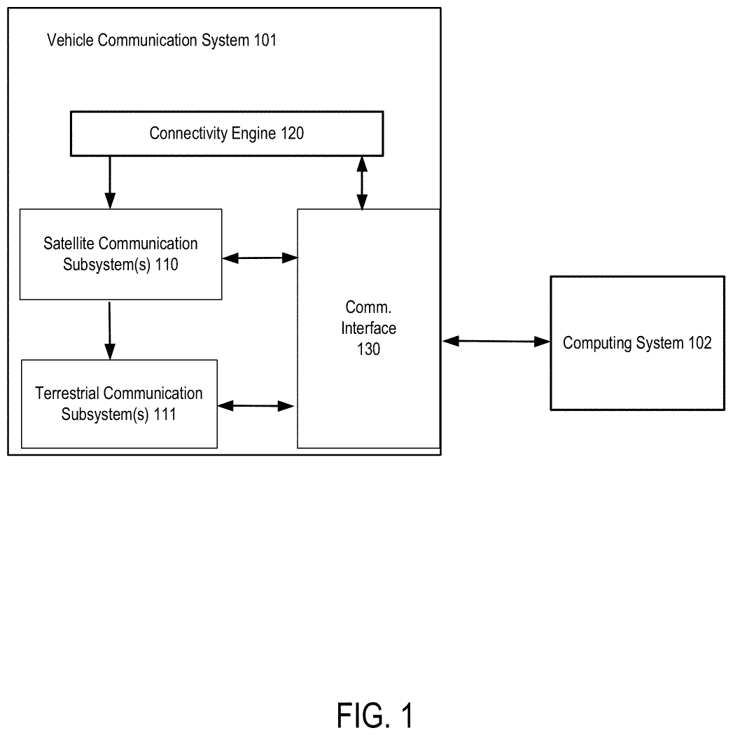

FIG. 1 is a block diagram of one embodiment of a portion of a vehicle. Referring to FIG. 1, a vehicle communication system 101 is communicably coupled to a computing system 102 in the vehicle. Computing system 102 may comprise a computer integrated into the vehicle, such as, for example, but not limited to, the car navigation system, car diagnostic system, or other car display system. Computing system 102 may also comprise a computer system in the car being used by a vehicle occupant, such as, for example, but not limited to, a lap top computer system, tablet, smartphone, personal digital assistant, IoT device, etc.

In one embodiment, vehicle communication system 101 is communicably coupled to a computing system 102 via a wired communication system (e.g., Ethernet, Universal Serial Bus (USB), or any other well-known wired communication system). In another embodiment, vehicle communication system 101 is communicably coupled to a computing system 102 via a wired communication system via a wireless connection (e.g., Bluetooth, Zigbee, infra-red, other short-range wireless communication systems, etc.).

In one embodiment, vehicle communication system 101 includes wireless communication functionality to transfer data to and from the vehicle using wireless communication. In one embodiment, vehicle communication system 101 includes one or more satellite communication subsystems 110 for communicating data to and from the vehicle using satellite communication. Examples of satellite communications systems include, but are not limited to, satellite 5G, GEO/LEO, HEO or other NTN constellations. Examples of satellite subsystems that may be part of vehicle communication system 101 are described in more detail below.

In another embodiment, vehicle communication system 101 also includes one or more terrestrial communication subsystems 111 for communicating data to and from the vehicle using terrestrial communication. Examples of terrestrial communication subsystems include terrestrial cellular communication systems (e.g., 5G, LTE, other cellular radio standards, etc.).

In one embodiment, satellite communication subsystems 110 and terrestrial communication subsystems 111 include transceivers having transmit and receive logic to operate as a transmitter and receiver, respectively, for communications with the vehicle.

In one embodiment, vehicle communication system 101 also includes a connectivity engine 120 that is coupled to the one or more satellite communication subsystems 110 for connecting to satellite networks including, but not limited to, one or more LEO, MEO or GEO satellite networks, and the one or more terrestrial communication subsystems 111 to control which communication subsystem is employed to provide communication between computing system 102 and locations external to the vehicle. In one embodiment, connectivity engine 120 performs a selection process to select among the communication subsystems to provide communication between computing system 102 and locations external to the vehicle. The selections may be based on available connectivity and user input. Note that in another embodiment, connectivity engine 120 that is not coupled to the one or more satellite communication subsystems and a hybrid module is responsible for switching between ground and the satellite.

In one embodiment, connectivity engine 120 proactively switches from a first communication connection being used by the vehicle to a second communication connection that is to be used by the vehicle. In one embodiment, the switch is performed in response to determining that the first communication connection is not going to be available. In this way, connectivity engine 120 proactively switches between communication connections in order to maintain communication between the vehicle and external locations.

In one embodiment, the first and second communication connections are made using the same communication subsystem. For example, in one embodiment, connectivity engine 120 controls one satellite subsystem 110 to switch between different satellites or switch between using different frequencies or carrier sizes of the same satellite subsystem. In another embodiment, connectivity engine 120 controls one of satellite subsystems 110 and one of terrestrial communication subsystems 111 to switch between a communication connection being made with one to a communication connection made with the other. For example, when a determination is made that communication connectivity is going to be lost when communicating with one of satellite subsystems 110, connectivity engine 120 proactively switches to a communication with a cellular communication system of terrestrial communication subsystems 111. There may be many reasons that communication connectivity with one of satellite subsystems 110 is going to be lost, such as, for example, satellite blockages due to topography of the route, foliage on the route, satellite bandwidth limitations, etc.

Vehicle communication system 101 further includes communication interface 130 that is controlled by connectivity engine 120 to provide a data and control interface between one or more satellite communication subsystems 110 and the one or more terrestrial communication subsystems 111 and computing device 102. Thus, based on which of satellite communication subsystems 110 or terrestrial communication subsystems 111 is being employed for communication with the vehicle, data and control information is transmitted and received using the communication subsystem selected by connectivity engine 120 via communication interface 130. In this manner, data is transmitted by computing device 102 to a location external to the vehicle by directing the data to the communication subsystem selected by connectivity engine 120 and using transmit logic to wirelessly transmit the data.

In one embodiment, communication interface 130 also routes data and information to connectivity engine 120. For example, the communication subsystem selected by connectivity engine 120 to handle communications with the vehicle may receive data that is for connectivity engine 120, and in such cases, that data is received by a receiver of the selected communication subsystem and routed to connectivity engine 120. In one embodiment, the data received by a receiver of the selected communication subsystem and routed to connectivity engine 120 is used by connectivity engine 120 to determine whether to proactively switch communication connections or used in generating notifications, warnings and alerts. In one embodiment, communication interface 130 routes data and other information between computing system 102 and connectivity engine 120. In one embodiment, this information includes internal data stored in and/or capture by the vehicle and used by connectivity engine 120 to determine whether to proactively switch communication connections. In one embodiment, this information includes notifications and/or warnings generated or sent by connectivity engine 120 to computing device 102 to alert a vehicle occupant. In one embodiment, the notifications and/or warnings alert a vehicle occupant of various communications conditions including zones of total discontinuity, and mitigating action that can be taken.

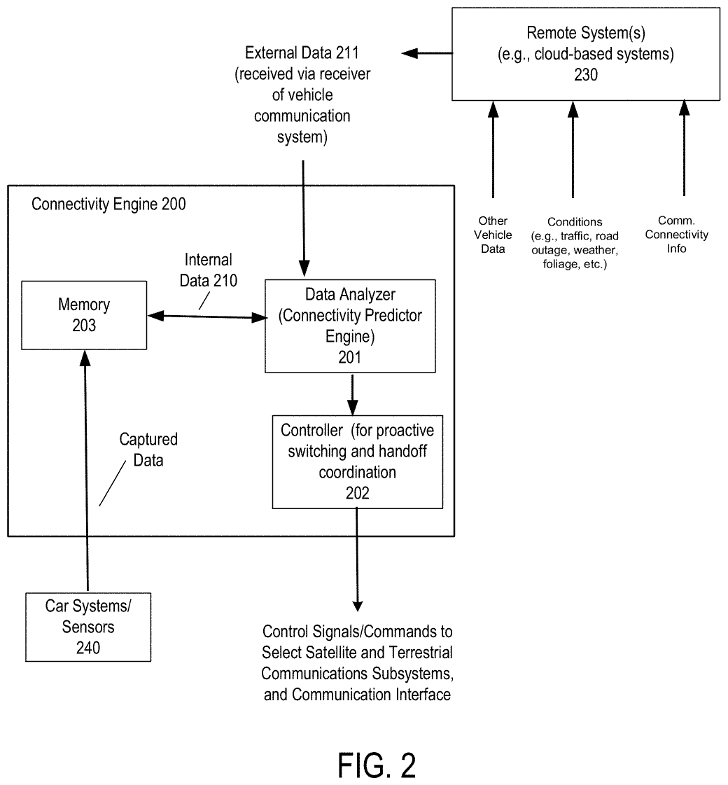

FIG. 2 is a block diagram of one embodiment of a connectivity engine. In one embodiment, the connectivity engine of FIG. 2 is used in the vehicle communication system of FIG. 1. In one embodiment, the connectivity engine comprises hardware (e.g., circuitry, dedicated logic, etc.), software and/or firmware.

Referring to FIG. 2, connectivity engine 200 comprises data analyzer 201, controller 202, and memory 203. Data analyzer 201 predicts when a communication connection being used will become unavailable along a route being traversed by the vehicle. In one embodiment, data analyzer 201 predicts when a communication connection being used will become unavailable using a connectivity prediction engine that executes a prediction algorithm.

In one embodiment, data analyzer 201 predicts when a communication connection being used will become unavailable based on internal data 210 and/or external data 211. In one embodiment, external data 211 comprises one or more of data related to the route being taken by the vehicle, such as one or more of traffic conditions, weather conditions, road outage conditions, foliage conditions, and connectivity outage or availability conditions of satellite and terrestrial communication systems.

In one embodiment, external data 211 is sent from one or more remote systems, such as remote system(s) 230. In one embodiment, remote system(s) 230 comprise one or more cloud-based systems. In one embodiment, remote systems 230 collects data regarding outages and current conditions from other vehicles, conditions along the route (e.g., traffic, weather, road outage, foliage, etc.), and connectivity information regarding the satellite and terrestrial communication systems (e.g., availability, reliability information, quality information, latency information, cost information, transfer speed, bit rate, etc.) and sends the information to connectivity engine 200. Note that some of the information may be provided directly from remote system(s) 230 to controller 202 (including commands or messages regarding predictions of unavailable connectivity and to proactively switching a connection).

In one embodiment, internal data 210 in stored in memory 203 and comprises one or more of route information indicating the route being taken by the vehicle and/or alternative routes available to the vehicle, direction of travel of the vehicle, current location of the vehicle, time of day information, vehicle speed, outage information that indicates when the vehicle suffered communication outages in the past and the locations at which they occurred, weather information, yaw and pitch of the satellite antenna in the vehicle, etc. Note that some of internal data 210 is data that was captured by one or more car sensors or systems 240. For example, the vehicle speed may be captured using the Controller Area Network bus (CAN bus) of the vehicle, current location of the vehicle may be obtained using by a GPS subsystem in the vehicle, and yaw and pitch of satellite antenna in the vehicle may be obtained from antenna settings.

Using the information that is received, data analyzer 201 generates a prediction that a first communication connection being used by the vehicle is not expected to be available at the location on the vehicle's route at the future time. In one embodiment, data analyzer 201 also determines when the vehicle is to be expected at the location. Data analyzer 201 provides this information to controller 202.

In response to the information from data analyzer 201, controller 202 determines whether to proactively switch from a first communication connection being used by the vehicle to a second communication connection. If so, controller 202 sends control signals and/or commands to one of the satellite communication subsystems (e.g., satellite communication subsystems 110 of FIG. 1) and/or one of the terrestrial communication subsystems (e.g., terrestrial communication subsystems 111 of FIG. 1), as well as the communication interface (e.g., interface 130, to switch communication connections.

In one embodiment, the control signals and/or commands sent by controller 202 to one of the satellite communication subsystems, and/or one of the terrestrial communication subsystems, and the communication interface are used to coordinate the handoff between the two communication connections in order to maintain a communication session that exists between the computing device of the vehicle and a location external to the vehicle. Using OSI model (7 layer) term, the control signals and/or commands only change the Layer 4 transport and Layer 3 network layer and all other layers are transparent to this control.

In one embodiment, data analyzer 201 and controller 202 comprise hardware software, firmware or a combination of all three.

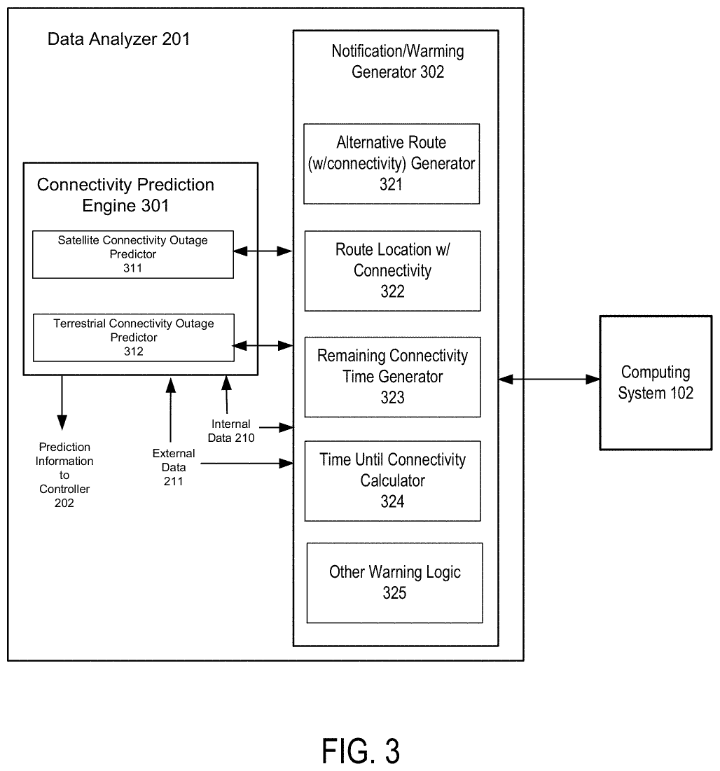

FIG. 3 is a block diagram of portions of a data analyzer 201 of FIG. 2. Referring to FIG. 3, data analyzer 201 includes a connectivity prediction engine 301 and a notification/warning generator 302. In one embodiment, connectivity prediction engine 301 comprises satellite connectivity outage prediction unit 311 to predict when satellite connectivity is not available and terrestrial connectivity outage prediction unit 312 to predict when terrestrial connectivity is not available.

In one embodiment, connectivity prediction engine 301 receives internal data 210 and external data 211 and uses this information to perform the predictions. These predictions are provided to controller 202 of FIG. 2, which controller 202 uses to determine whether to proactively switch between communication connections. In one embodiment, connectivity prediction engine 301 only sends the prediction related to the communication connection currently being used by the vehicle to controller 202 so that controller 202 is able to determine whether a switch should be performed.

In one embodiment, the outputs of satellite connectivity outage prediction unit 311 and terrestrial connectivity outage prediction unit 312 are input to notification/warning generator 302 along with internal data 210 and external data 211. In response to these inputs, notification/warning generator 302 generates one or more notifications that are sent to and displayed on a display screen of computing device 102 in the vehicle. The display screen may be the display screen for an integrated vehicle computer system. For example, the display screen may be screen of a navigational system in the vehicle. Alternatively, the display screen may be part of a computer system or other device of a vehicle occupant.

In one embodiment, the notifications and warnings allow a vehicle occupant to take action based on determining the antenna is going to be traversing an area of poor connectivity. For example, when warned that communication connectivity is ending, the vehicle occupant may decide to download an entire movie that is being streamed because communication will be unavailable in a predetermined period of time (e.g., a certain number of minutes). Alternatively, the notifications also may provide options to find connectivity or enable the vehicle to pull off road to continue the connection, particularly where in the past the vehicle (or other vehicles) has lost connectivity for a period of time (e.g., 20 mins) near the current location in the route.

In one embodiment, notification/warning generator 302 includes logic to determine and generate a number of notifications and warnings. In one embodiment, notification/warning generator 302 includes an alternative route notification generator 321 that uses information from internal data 210 and/or external data 211 to determine one or more alternative routes that the vehicle may take for which there is connectivity. In one embodiment, the alternative routes are characterized by data type so that a user is notified of the type of connectivity with respect to each route. The routes may also be characterized by reliability, quality, latency, security, data transfer speed, network type, and/or cost. Notification/warning generator 302 sends any such routes to computing device 102 for display on its display screen.

In one embodiment, notification/warning generator 302 includes a route location with connectivity generator 322 that uses information from internal data 210 and/or external data 211 to determine a route that the vehicle may take and/or a location for which there is connectivity along with the time it would take for the vehicle under its current speed, traffic, road and weather (e.g., temperature) conditions to reach that location. In one embodiment, the alternative route is characterized by one or more of data type (to enable a user to know the type of connectivity with respect to the route) and characteristics of the available communication connection, such as, for example, but not limited to, reliability, quality, latency, data transfer speed, network type, and/or cost. Notification/warning generator 302 sends a notification of the route to computing device 102 for display on its display screen.

In one embodiment, notification/warning generator 302 includes remaining connectivity time generator 323 that uses information from internal data 210 and/or external data 211 to determine the remaining time that the vehicle will have connectivity (i.e., how long connectivity remains open). Notification/warning generator 302 sends the calculated time to computing device 102 for display on its display screen to notify the user of a finite time period that exists before connectivity is lost and/or the timing remaining to communicate outside the vehicle using the communication subsystems. In one embodiment, the remaining time for connectivity counts down as a timer on the display screen of computing device 102.

In one embodiment, notification/warning generator 302 includes a time-to-connectivity calculator 324 that uses information from internal data 210 and/or external data 211 to determine the amount of time until the vehicle will be able to obtain connectivity along its current route under its current speed, road and weather (e.g., temperature) conditions. Notification/warning generator 302 sends a notification indicating this amount of time to computing device 102 for display on the display screen and services can be adjusted and download times changed to accommodate the impending outage. In one embodiment, the services intelligently anticipate the connectivity state of the anticipated path based on the embodiments described herein and adjusts the delivery of applications, services, updates and other notifications to the vehicle. In one embodiment, files can be delivered at a higher baud rate, they can be assigned a higher priority assignment and delivered before other content, or they can be held for a more optimum transfer time. Note that in one embodiment, files can be held in a best cost system or sent at a higher baud rate or with a higher priority before the total blockage occurs.

In one embodiment, notification/warning generator 302 includes other warning logic 325 that generators other notifications and warnings for display. These warnings could alert a vehicle occupant as to conditions along the route such as, for example, road outages, weather conditions, etc.

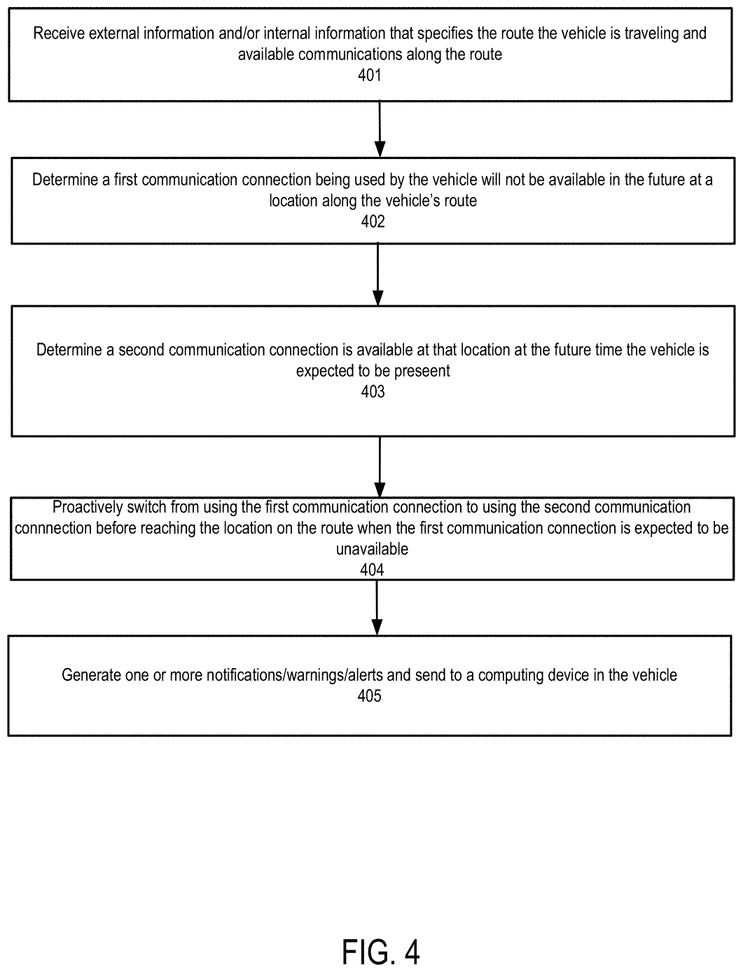

FIG. 4 is a flow diagram of one embodiment of a process for managing communications from a vehicle. In one embodiment, the processes are performed by processing logic that may comprise hardware (e.g., circuitry, dedicated logic, etc.), software (e.g., software running on a chip), firmware, or a combination of the three.

In one embodiment, the vehicle includes a satellite communication subsystem with a satellite antenna. In one embodiment, the satellite antenna is a flat-panel antenna. In another embodiment, the satellite antenna is an electronically steered flat-panel antenna. Examples of such electronically steered flat-panel antennas are described in more detail below.

Referring to FIG. 4, the process begins by receiving external information and/or internal data that specifies information regarding the route the vehicle is traveling and regarding the communications that are available along the route (processing block 401). In one embodiment, the information includes traffic conditions, weather conditions, road outage conditions.

Next, processing logic determines a first communication connection being used by the vehicle is not expected to be available in the future at a location on the route that is to be traversed (processing block 402). For example, based on past experiences of the vehicle and/or other vehicles as indicated by history data that has been stored and/or sent to the vehicle, a determination may be made that satellite communication regularly, seasonally, or always has an outage at a particular location along a route.

After determining that a first communication connection being used by the vehicle is not expected to be available in the future at a particular location along the route being taken by the vehicle, processing logic determines a second communication connection is available or potentially available at that location (processing block 403).

Once a second communication connection has been identified, processing logic proactively switches from using the first communication connection to using the second communication connection before reaching the location on the route when the first communication connection is expected to be unavailable (processing block 404).

In one embodiment, the first and second communication connections are satellite connections. In one embodiment, the two satellite connections are made with the same satellite antenna of the satellite subsystem of the vehicle. For example, in one embodiment, the two connections are for different frequencies with the same satellite antenna. In another example, in one embodiment, the two connections for the same satellite are for different carrier sizes.

In one embodiment, the first and second communication connections include a satellite connection and a terrestrial network connection. For example, in one embodiment, the first connection is a satellite communication connection while the second communication connection is for a cellular connection, such that the vehicle is proactively switched from using a satellite connection to using a cellular connection before the satellite connection becomes unavailable.

In one embodiment, proactively switching between the first and second communication connections includes making a handoff of the communication session from the first to the second communication connection. In one embodiment, the handoff of the session occurs with the IP address being maintained for the session. In one embodiment, to the network core, the vehicle communication system looks like one session in that it has one IP address and is integrated at level 3 on the network stack. Thus, in one embodiment, the current IP address and session is maintained irrespective of the amount of path switching occurs so the session (e.g., Internet session) is maintained and the application or service is not interrupted.

In one embodiment, a cloud server maintains all connections and a common IP address is used. However, in such a system, all the traffic must be routed through the same gateway.

The processing logic optionally includes generating one or more notifications/alert/warnings and sending them for display on a display screen of a computing device (processing block 405).

In one embodiment, a remote system (e.g., remote system 230) in the communication system includes cloud-based analytics that store the satellite and terrestrial connection availability, quality (as measured by latency and bit rate) for every road of interest. In one embodiment, this system's model measures and stores a history of blockages by satellite, terrestrial and terminal type. In one embodiment, this measure is also sensitive to seasonal, solar and concomitant foliage changes, construction, road closures, manmade or natural disaster, atypical events that can overwhelm the capacity of a given network, and other changes that effect connectivity. In one embodiment, this system has an algorithm (e.g., a randomizing algorithm) that continues to challenge the system's model to account for changes in topographical and communication technology. Using this information, the remote system is able to determine when the vehicle communication system should proactively switch communication connections.

In one embodiment, the remote system includes a database and best cost routing engine to determine best cost routing based on business rules. In one embodiment, the routing determination is based on one or more of the following: application type/data type/security requirements, privacy, data locality and sovereignty, DRM (digital rights management), and applicability for multicast, broadcast or unicast. In one embodiment, data is prioritized based on urgency and latency requirements and sent on the path at an intersection (e.g., an optimum intersection) of cost and urgency.

In one embodiment, the remote system includes a predictive algorithm for ascertaining the period of time, based on current weather, road, and traffic conditions before 1) the switch to the other network path should be made, 2) if it is appropriate based on the business rules for that type of data, and 3) if it is not possible or not appropriate, then warning the driver of the number of seconds before this connection is lost. When the remote system has determined that the vehicle should proactively switch communication connections based on this information, the remote system sends communications (e.g., messages, commands, signals, etc.) to the connectivity engine of the vehicle (e.g., commands sent directly to controller 202 of FIG. 2) to cause the proactive switching to occur.

Note that in one embodiment, the data analyzer of the connectivity engine of a vehicle includes the functionality and processing power necessary to perform these analytics and/or execute these algorithms.

The operation of one embodiment of the remote system that causes proactively switching of communication connections may be illustrated in an example. In this example embodiment, the data analysis is performed in a remotely-located system (e.g., a cloud-based system), referred to as a connectivity system, as opposed to being performed on the vehicle itself. Note that in another embodiment, such a connectivity system is integrated into the vehicle. An automobile is traveling on a public or private road, or an off-road trail, and has the vehicle communication system described above. The remotely-located connectivity system is sending and receiving data (e.g., external data 211) to and from the automobile, respectively. In one embodiment, communication techniques used to send and receive this data are: by a terrestrial communication system (e.g., 5G, LTE and other cellular communication, Wi-Fi and DSRC, etc.) and by a satellite communication system (e.g., satellite based 5G and other non-terrestrial network (NTN) standards that are in various standard NTN constellations that include, but are not limited to, LEO, GEO and HEO constellations).

Based on the experience of all similarly equipped vehicles of the fleet from a specific OEM that has been captured and stored in the connectivity system (representing external data 211) and the individual history of the vehicle itself and the current experience that vehicle (representing internal data 210), in one embodiment, the connectivity system determines the optimum point of data paths between the terrestrial-based system and the satellite-based system and makes a new communication connection to the new path before breaking the previous path. The current IP session is maintained, and the application has no knowledge of the switch in paths. The user has no indication that the path has changed.

In one embodiment, if the connectivity system determines that there is no new path to be had or if the new path does not meet the requirements of the data for security, latency, cost, or other business or technology criteria, the connectivity system generates and provides the driver or other vehicle occupant with a notification (e.g., a warning) on a display of or in the vehicle of the time to discontinuity of data connection based on current speed, road, and traffic conditions. In one embodiment, the connection areas and discontinuity points are displayed on the vehicle's built-in navigation system.

As another example, assume a driver is driving a vehicle through a rural county. The vehicle communication system is connected via LEO satellites to the internet. Based on the connectivity experience of 100s of similarly-enabled vehicles that have passed this point whose experience is stored in the vehicle (e.g., external data), the connectivity engine of the vehicle communication system determines when and where connectivity discontinuity will likely take place at the vehicle's speed on the target road on the route. The connectivity engine updates based on experience, such as blockage caused by tunnel, foliage or building construction, changes in the terrestrial system and changes in the satellite systems.

In one embodiment, the connectivity engine “bonds” the IP traffic to the new path (in this case the terrestrial source) before breaking with the previous path (in this case the satellite capacity), thereby providing a seamless user experience for the vehicle occupant. In one embodiment, the bonding is performed by updating routing rules before breaking with the previous connection path so that packets are forwarded along the best path toward its destination over an IP network. This may be facilitated by a routing table implemented in Windows or Linux OS. If there is no alternative path, the connectivity engine generates and sends a notification for display on a display screen in the vehicle to a vehicle occupant which advises the vehicle occupant (e.g., the driver) where the discontinuity will occur and when it will occur. Further, in one embodiment, the connectivity engine advises the vehicle occupant of a safe place to navigate and stop the vehicle if the occupant chooses to continue the data session (e.g., in this case a voice conversation), if necessary.

Note that with respect to the example above, in alternative embodiments, these operations performed by the connectivity engine may be performed by a remotely located system and provided to the connectivity engine.

Embodiments of the invention include one or more of a number of innovations described herein, including, but not limited to, the following:
Data into and out of the vehicle is differentiated and then routed to Non-Terrestrial-Networks (NTNs) or terrestrial based on a set of rules (e.g., business rules),
Communication connections are made before the previous connections are broken based on the experience of a vehicle and all such equipped vehicles that have ever traveled this route between terrestrial and NTNs,
One or more remotely-located systems (e.g., cloud-based servers) are collecting the terrestrial and NTN connectivity data for use in forecasting when to switch communication connections for all data types and a data particular data type, and
When a discontinuity in communication connection service is to occur, a notification generator sends a notification/warning/alert to warn vehicle occupants and/or relevant systems and/or provide suggestions for and/or implement alternative strategies to maintain connectivity.

Embodiments of the invention are useful in one or more of the following ways:
Dead zones are anticipated and mitigated by switching or informing a vehicle occupant (e.g., driver, computing device user, etc.),
Discontinuities that are hazardous to mission critical or autonomous systems can be planned around, or the vehicle can be stopped in areas where connectivity exits. Discontinuities that are inconvenient to humans can be mitigated with alternatives and warnings, and
Constant contact is maintained and the best route for the particular datatype is exploited.

### Proactively Switching Between Connections of the Same Satellite

In one embodiment, proactively switching between communication connections is performed using one satellite antenna that generates two beams at the same time, where communication is switched from one beam used for the current communication connection to a second beam used for the new connection when the current communication connection is no longer available.

In one embodiment, a satellite communication system that includes a single antenna is able to go from generating one beam for the current communication connection to generating two beams where one beam is used to maintain the current communication connection and the other beam is used for obtaining communication connectivity with another satellite or the same satellite at a different frequencies or carrier size. In one embodiment, the antenna is a flat-panel antenna. In another embodiment, the satellite antenna is an electronically steered flat-panel antenna. Examples of such electronically steered flat-panel antennas are described in more detail below.

In one embodiment, the antenna is an electronically steered flat-panel antenna and is used by generating an electronically steered antenna beam pattern for beamforming, sending the beam pattern to an antenna aperture of an electronically steered flat-panel antenna having a set of radio-frequency (RF) radiating antenna elements (e.g., surface scattering metamaterial antenna elements, such as, for example, but not limited to, those described below), and generating a receive beam with the RF radiating antenna elements based on the antenna pattern for the current communication connection and generating at least one additional receive beam with the antenna to track a second satellite (or the same first satellite) simultaneously while continuing to generate the receive beam pointing to and tracking the first satellite. In one embodiment, when the multi-beam mode is in a dual-beam mode, the antenna generates two receive beams for pointing to and tracking two satellites, where the two satellites include the satellite to which the antenna was pointing and tracking during the previous single-beam configuration and a new satellite from which the antenna acquired a signal and began tracking with the second beam while in the multi-beam configuration.

Thereafter, after tracking of an additional satellite, the proactive switching between the two communication connections may be performed, including handing off traffic from the satellite being tracked while in the previous single-beam configuration to the new satellite. In one embodiment, handing off traffic is performed seamlessly such that connectivity is maintained throughout the transition from the previously tracked satellite to the new satellite.

In one embodiment, the first and second beams point at carriers that are at different frequencies. In one embodiment, the first and second beams have different antenna gains, wherein gain for the second beam is lower than the gain for the first beam. In one embodiment, this occurs when the second beam is used for acquiring the signal from the second satellite. In one embodiment, the second beam is wider than the first beam when used for acquiring the signal from the second satellite. In one embodiment, the beam is made wider to allow capture of a signal when there is some uncertainty as to the exact location of the signal. In one embodiment, the amount to widen the beam depends on the degree of uncertainty about the location of the signal. In one example embodiment, if the beam during pointing and tracking is less than 2 degrees wide, then the beam for acquisition is broadened to about (but not limited to) 10 degrees wide. Note that this is merely an example, and the beam is not limited to being 10 degrees wide during acquisition. However, if the beam is too wide there is a risk of picking up another satellite.

In one embodiment, the RF radiating antenna elements of the two sets for generating the two beams simultaneously are different from each other but are part of the RF radiating antenna elements of the antenna. In one embodiment, the two sets of RF radiating antenna elements for generating the two beams simultaneously when operating the antenna in a dual-receive beam configuration are part of, or comprise all of, the RF radiating antenna elements that are used for generating one beam when operating the antenna in a single-beam configuration.

In one embodiment, the two sets of RF radiating antenna elements have a different number of RF radiating antenna elements (e.g., 75% of the antenna elements used for generating the first beam and 25% of the antenna elements used for generating the second beam during signal acquisition). The number of elements used to generate each of the beams depends on the satellites for a minimum gain level. In one embodiment, for specific satellites/scenarios, there could be 10+dB signal-to-noise ratio (SNR) so the two radiation patterns could be offset by that much. However, in other scenarios, differences of more or less than 10+dB may be sufficient.

Techniques described above are performed by an antenna that is used in satellite communication. In one embodiment, the antenna comprises an electronically steered flat-panel antenna aperture with a plurality of electronically controlled radio frequency (RF) radiating antenna elements (e.g., surface scattering metamaterial antenna elements or resonators such as, for example, described in more detail below), and one or more processors coupled to the antenna aperture to control the antenna aperture such that the antenna aperture generates a first beam with the antenna aperture to track a first satellite, generates a second beam with the antenna aperture to track a second satellite simultaneously while generating the first beam, and hands off traffic from the first satellite to the second satellite. In one embodiment, the processor hands off traffic seamlessly between the first and second satellites such that connectivity is maintained throughout the transition from the first satellite to the second satellite.

In one embodiment, prior to generating the second beam to track the second satellite, a processor controls the antenna aperture to generate the second beam to acquire a signal from the second satellite while generating the first beam. In one embodiment, the processor generates first and second patterns to apply to first and second sets of first and second sets of radio-frequency (RF) radiating antenna elements, respectively, of the antenna aperture to generate the first and second beams, respectively, to point at carriers that differ in frequency.

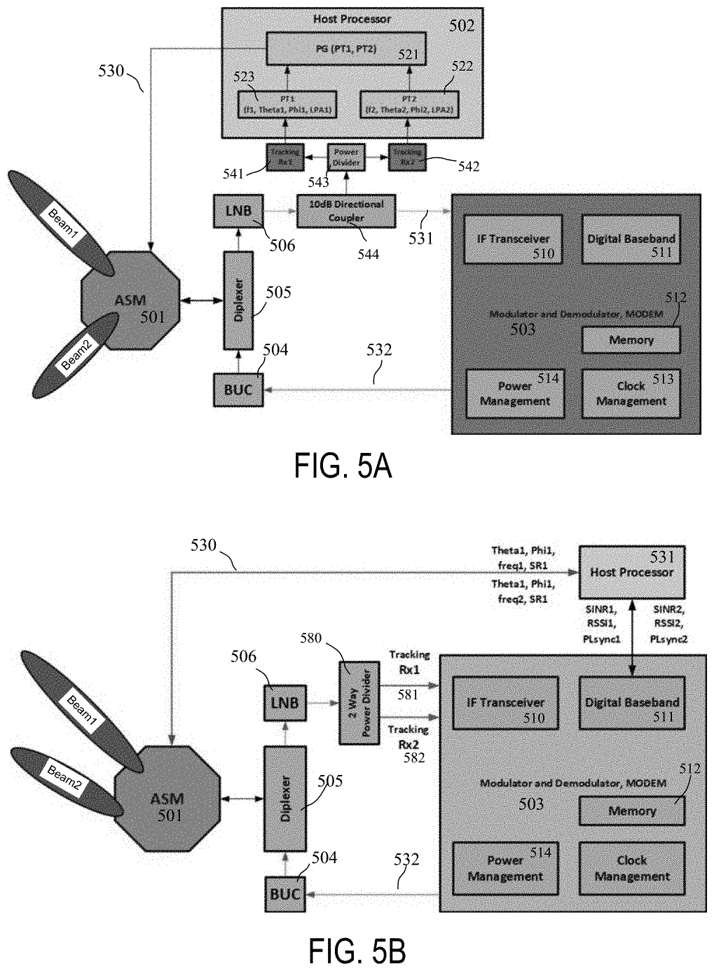

FIG. 5A is an example of a satellite antenna architecture that is capable of generating one receive beam or two receive beams simultaneously to facilitate handing off communication between two satellites, particularly when used to proactively switch between communication connections.

Referring to FIG. 5A, host processor 502 receives satellite location (e.g., latitude and longitude) and polarization information, and in response to these inputs, performs antenna receive pointing by generating pointing and tracking information that is provided to and controls antenna elements of an antenna aperture of antenna system module (ASM) 501. Examples of such an antenna aperture having RF radiating antenna elements (e.g., surface scattering antenna elements or resonators) are described in more detail below. In one embodiment, the pointing and tracking information is associated with electronically controlled antenna wave patterns that are used to control the RF radiating antenna elements as described herein.

In one embodiment, the pointing and tracking information comprises a pointing angle (e.g., theta, phi), frequency information and symbol rate information. The theta range may be [0,90] degrees, the phi range may be [0,360] degrees. In one embodiment, host processor 502 also generates polarization values that are provided to the antenna aperture of ASM 501. The polarization value may range from [0,360] degrees. In one embodiment, the polarization values are generated by host processor 502 in a manner well-known in the art.

The receive portion of antenna aperture of ASM 501 uses the new pointing angle to generate a beam to obtain an RF signal from a satellite and provide it to modem 503. In one embodiment, when only one set of pointing information is sent by host processor 502 to ASM 501, the antenna aperture of ASM 501 generates one receive beam using all of the RF radiating antenna elements that are designated for receive transmissions (as opposed to those used for transmit) and the receive beam is used to obtain the RF signal from the satellite.

In response to a received RF signal, modem 503 generates receive metrics (e.g., SNR, C/N, etc.) regarding the receive (Rx) signal being received. In one embodiment, the receive metrics indicate whether the satellite signal has been found based on whether the signal meets one or more predetermined criterion (e.g., SNR or C/N greater than a predetermined threshold) in a manner well-known in the art.

In one embodiment, host processor 502 provides two sets of pointing and tracking information to the antenna aperture of ASM 501, where each set of pointing and tracking information is for controlling a different set of antenna elements of the antenna aperture of ASM 501, to enable ASM 501 to generate beams 1 and 2. That is, host processor 502 sends two sets of pointing and tracking information to ASM 501 to generate two receive beams simultaneously using different sets of antenna elements of the antenna aperture of ASM 501. In one embodiment, the two receive beams are generated by dividing one set of antenna elements into two groups (e.g., every other ring of antenna elements, or every other antenna element in a ring or distribution, or randomly distributed) and forming two independent beams, at the same frequency or at different frequencies within the dynamic bandwidth of that element type. This can be at different thetas or at the same theta.

In one embodiment, in order to generate an electronically steered antenna pattern, host processor 502 sends commands to an antenna control process (ACP) module on ASM 501 to start tracking a target satellite, and in response to the information, the ACP module sends setup information and continuously calculates and sends pointing vectors to a service. In one embodiment, the ACP module sends setup and pointing information comprised of an operating frequency (e.g., f1, f2) and polarization values for the antenna aperture at ASM 501 as setup information and a pointing vector having theta, phi and linear polarization angle (LPA) values as the pointing information to the pattern generation service.

In response to the setup and pointing information, the service provides a plurality of electronically steered antenna patterns that control antenna elements (e.g., RF radiating antenna elements (e.g., metamaterial scattering antenna elements)) of the antenna aperture to form the two receive beams. In one embodiment, this service comprises a software service that is executed by one or more processors of ASM 501. In another embodiment, this service comprises hardware on ASM 501.

In one embodiment, pattern generation service loads beamforming parameters into an FPGA corresponding to the patterns. In response, the FPGA outputs the pattern to the antenna elements of the electronically steered antenna in the form of digital-to-analog (DAC) values (for each pattern). More specifically, a DAC value for each antenna element in the antenna aperture is calculated by the FPGA using the beamforming parameters provided by the pattern generation service. The FPGA then outputs control signals to the antenna elements to drive the calculated pattern. In one embodiment, the DAC values control thin film transistors (TFTs) in order to control the antenna elements of the antenna aperture (not shown) to generate a beam. Examples of TFT and their control are described in more detail below.

After each of the two beams, beam 1 and beam 2, has been formed in response to patterns generated by the pattern generation service of ASM 501, a receiver on ASM 501 receives a signal back from the use of each receive beam and provides that to diplexer 505. From diplexer 505, the signals are processed by Low Noise Block (LNB) 506, which performs a noise filtering function and a down conversion and amplification function in a manner well-known in the art. Note that in FIG. 5A, in one embodiment, as the signals from the two beams are different in frequencies, LNB 506 covers both frequencies simultaneously. In one embodiment, LNB 506 is in an out-door unit (ODU). In another embodiment, LNB 506 is integrated into the antenna apparatus.

After signal processing by LNB 506, the signal is sent to a directional coupler 544, which couples energy from the received signal output from LNB 506 to an Rx power divider 543 and to modem 503 (as signal 531). In one embodiment, directional coupler 544 is a 10 dB directional coupler; however, other couplers may be used.

Rx power divider 543 splits the signal received from directional coupler 544 into two signals and sends one signal to tracking receiver 541 and the other signal to tracking receiver 542. In one embodiment, the signals are split based on frequency, such that the signals associated with beam 1 are sent to one of tracking receivers 541 and 542, while the signals associated with beam 2 are sent to the other of tracking receivers 541 and 542. Note that if the antenna is operating in a single-beam mode and only generating one receive beam, then Rx power divider 543 provides the one signal to only one of tracking receivers 541 or 542 and no signal to the other. In one embodiment, Rx power divider is a diplexer. Alternatively, Rx power divider 543 comprises a power splitter or a frequency adjustable filter.

In response to signal 531, modem 503 processes signal 531 in manner well-known in the art. More specifically, modem 503 includes an analog-to-digital converter (ADC) to convert the received signal output from directional coupler 544 into digital format. Once converted to digital format, the signal is demodulated by a demodulator and decoded by decoder to obtain the encoded data on the received wave. The decoded data is then sent to a controller, which sends it to its destination (e.g., a computer system).

Modem 503 also includes an encoder that encodes data to be transmitted. The encoded data is modulated by a modulator and then converted to analog by a digital-to-analog converter (DAC) (not shown) to produce analog signal 532. Analog signal 532 is then filtered by a BUC (a block upconverter) 504 and provided to one port of diplexer 505. In one embodiment, BUC 504 is in an out-door unit (ODU). Diplexer 505 operating in a manner well-known in the art provides the transmit signal 532 to ASM 501 for transmission.

In one embodiment, to support its operations, modem 503 includes an intermediate frequency (IF) transceiver 510 to process transmit and receive signals at an intermediate frequency, a digital baseband processor 511 to process down-converted digital signals to retrieve data for a digital system, memory 512 stores parameters, data tables, and other information used by the modem to perform modulation, demodulation and its other functions, a clock management unit 513 to managing clocking of operations of modem 503, and a power management unit 514 to manage power consumption of modem 503. These unit operate in a manner well-known in the art unless specified otherwise.

In operation, in one embodiment, as one satellite begins to leave the field of view of the terminal, the antenna aperture of ASM 501 is controlled so that it changes from the single-beam configuration into two beams and begins setting up a connection with the next satellite with the second beam. In one embodiment, the second beam is only for locating and connecting with the next satellite and not transmitting large amounts of data, and thus the gain of the second beam with respect to the primary beam is lower, allowing for reduced, and potentially minimal, impact onto the data transmission rates of the satellite terminal.

In one embodiment, two beams are generated simultaneously with a single electronically steered flat antenna in order to access a satellite, and then a handoff of traffic from a first beam to a second beam happens seamlessly, whereas the first beam and the second beam are pointed at the same satellite, yet are accessing satellite carriers on distinct frequencies. An example of this is shown in FIG. 5B.

Referring to FIG. 5B, host processor 531 generates pointing and tracking information 530 and sends it to ASM 501 for one or two receive beams. In one embodiment, pointing and tracking information 530 includes theta (e.g., Theta1), phi (e.g., Phi1), frequency (e.g., freq1, freq2), and symbol rate (e.g., SR1) information. This may be in response to signal quality information or metrics, such as, for example, SINR values (e.g., SINR1, SINR2) or Received Signal Strength Indicator (RSSI) (e.g., RSSI1, RSSI2) associated with received signals associated with received beams 1 and 2. In one embodiment, this is in response to physical layer synchronization signals (e.g., PLsynch1, PLsynch2) that indicate that the antenna beam is tracking a satellite. In one embodiment, the signal quality information or metrics and sync signals are received from modem 503.

Using beams 1 and 2, the antenna aperture of ASM 501 receives signals from one or two satellites. The received signals are sent to diplexer 505 and then to LNB 506, which operates as discussed above. From LNB 506, the signals are sent to 2-way power divider 580, which divides the received signal into tracking receive signal (Rx1) 581 and tracking receive signal (Rx2) 582. In one embodiment, tracking receive signal (Rx1) 581 and tracking receive signal (Rx2) 582 terminate at an RF tuner inside modem 503 where the frequency selection occurs. In this case, power divider 580 is a simple power splitter. In another embodiment, power divider 580 operates as a bandpass filter to filter the incoming signal to produce tracking receive signal (Rx1) 581 and tracking receive signal (Rx2) 582. These signals are sent to modem 503 and processed as described above.

Although not shown in FIG. 5B, in one embodiment, a second splitter/power divider is placed before LNB 506 and is included to split between Rx1 and Rx2.

### Examples of Antenna Embodiments

The techniques described above may be used with flat panel antennas. Embodiments of such flat panel antennas are disclosed. The flat panel antennas include one or more arrays of antenna elements on an antenna aperture. In one embodiment, the antenna elements comprise liquid crystal cells. In one embodiment, the flat panel antenna is a cylindrically fed antenna that includes matrix drive circuitry to uniquely address and drive each of the antenna elements that are not placed in rows and columns. In one embodiment, the elements are placed in rings.

In one embodiment, the antenna aperture having the one or more arrays of antenna elements is comprised of multiple segments coupled together. When coupled together, the combination of the segments form closed concentric rings of antenna elements. In one embodiment, the concentric rings are concentric with respect to the antenna feed.

### Examples of Antenna Systems

In one embodiment, the flat panel antenna is part of a metamaterial antenna system. Embodiments of a metamaterial antenna system for communications satellite earth stations are described. In one embodiment, the antenna system is a component or subsystem of a satellite earth station (ES) operating on a mobile platform (e.g., aeronautical, maritime, land, etc.) that operates using either Ka-band frequencies or Ku-band frequencies for civil commercial satellite communications. Note that embodiments of the antenna system also can be used in earth stations that are not on mobile platforms (e.g., fixed or transportable earth stations).

In one embodiment, the antenna system uses surface scattering metamaterial technology to form and steer transmit and receive beams through separate antennas. In one embodiment, the antenna systems are analog systems, in contrast to antenna systems that employ digital signal processing to electrically form and steer beams (such as phased array antennas). In one embodiment, the antenna system is comprised of three functional subsystems: (1) a wave guiding structure consisting of a cylindrical wave feed architecture; (2) an array of wave scattering metamaterial unit cells that are part of antenna elements; and (3) a control structure to command formation of an adjustable radiation field (beam) from the metamaterial scattering elements using holographic principles.

### Antenna Elements

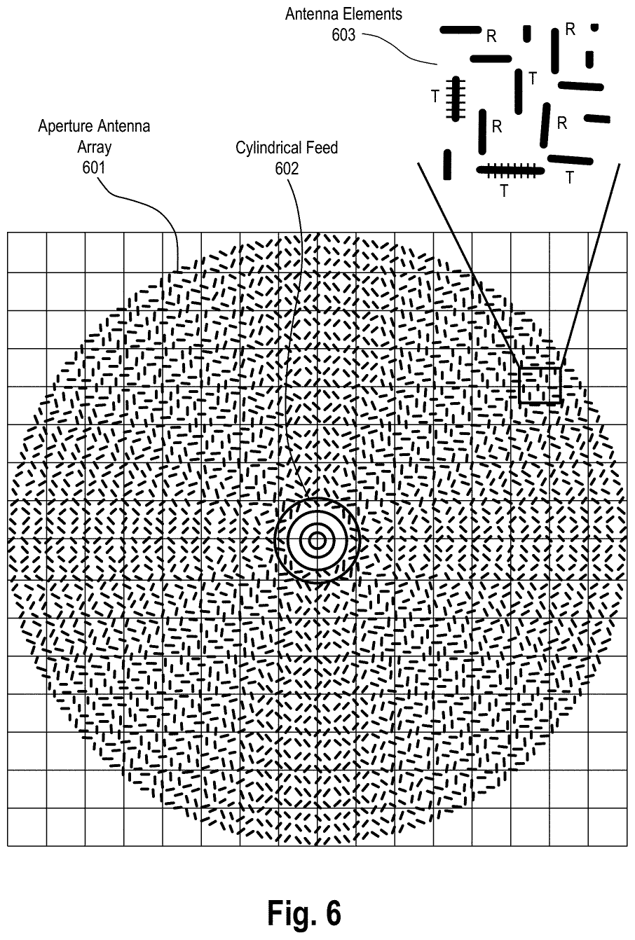

FIG. 6 illustrates the schematic of one embodiment of a cylindrically fed holographic radial aperture antenna. Referring to FIG. 6, the antenna aperture has one or more arrays 601 of antenna elements 603 that are placed in concentric rings around an input feed 602 of the cylindrically fed antenna. In one embodiment, antenna elements 603 are radio frequency (RF) resonators that radiate RF energy. In one embodiment, antenna elements 603 comprise both Rx and Tx irises that are interleaved and distributed on the whole surface of the antenna aperture. Such Rx and Tx irises, or slots, may be in groups of three or more sets where each set is for a separately and simultaneously controlled band. Examples of such antenna elements with irises are described in greater detail below. Note that the RF resonators described herein may be used in antennas that do not include a cylindrical feed.

In one embodiment, the antenna includes a coaxial feed that is used to provide a cylindrical wave feed via input feed 602. In one embodiment, the cylindrical wave feed architecture feeds the antenna from a central point with an excitation that spreads outward in a cylindrical manner from the feed point. That is, a cylindrically fed antenna creates an outward travelling concentric feed wave. Even so, the shape of the cylindrical feed antenna around the cylindrical feed can be circular, square or any shape. In another embodiment, a cylindrically fed antenna creates an inward travelling feed wave. In such a case, the feed wave most naturally comes from a circular structure.

In one embodiment, antenna elements 603 comprise irises and the aperture antenna of FIG. 6 is used to generate a main beam shaped by using excitation from a cylindrical feed wave for radiating irises through tunable liquid crystal (LC) material. In one embodiment, the antenna can be excited to radiate a horizontally or vertically polarized electric field at desired scan angles.

In one embodiment, the antenna elements comprise a group of patch antennas. This group of patch antennas comprises an array of scattering metamaterial elements. In one embodiment, each scattering element in the antenna system is part of a unit cell that consists of a lower conductor, a dielectric substrate and an upper conductor that embeds a complementary electric inductive-capacitive resonator (“complementary electric LC” or “CELC”) that is etched in or deposited onto the upper conductor. As would be understood by those skilled in the art, LC in the context of CELC refers to inductance-capacitance, as opposed to liquid crystal.

In one embodiment, a liquid crystal (LC) is disposed in the gap around the scattering element. This LC is driven by the direct drive embodiments described above. In one embodiment, liquid crystal is encapsulated in each unit cell and separates the lower conductor associated with a slot from an upper conductor associated with its patch. Liquid crystal has a permittivity that is a function of the orientation of the molecules comprising the liquid crystal, and the orientation of the molecules (and thus the permittivity) can be controlled by adjusting the bias voltage across the liquid crystal. Using this property, in one embodiment, the liquid crystal integrates an on/off switch for the transmission of energy from the guided wave to the CELC. When switched on, the CELC emits an electromagnetic wave like an electrically small dipole antenna. Note that the teachings herein are not limited to having a liquid crystal that operates in a binary fashion with respect to energy transmission.

In one embodiment, the feed geometry of this antenna system allows the antenna elements to be positioned at forty-five degree (45°) angles to the vector of the wave in the wave feed. Note that other positions may be used (e.g., at 40° angles). This position of the elements enables control of the free space wave received by or transmitted/radiated from the elements. In one embodiment, the antenna elements are arranged with an inter-element spacing that is less than a free-space wavelength of the operating frequency of the antenna. For example, if there are four scattering elements per wavelength, the elements in the 30 GHz transmit antenna will be approximately 2.5 mm (i.e., ¼th the 10 mm free-space wavelength of 30 GHz).

In one embodiment, the two sets of elements are perpendicular to each other and simultaneously have equal amplitude excitation if controlled to the same tuning state. Rotating them +/−45 degrees relative to the feed wave excitation achieves both desired features at once. Rotating one set 0 degrees and the other 90 degrees would achieve the perpendicular goal, but not the equal amplitude excitation goal. Note that 0 and 90 degrees may be used to achieve isolation when feeding the array of antenna elements in a single structure from two sides.

The amount of radiated power from each unit cell is controlled by applying a voltage to the patch (potential across the LC channel) using a controller. Traces to each patch are used to provide the voltage to the patch antenna. The voltage is used to tune or detune the capacitance and thus the resonance frequency of individual elements to effectuate beam forming. The voltage required is dependent on the liquid crystal mixture being used. The voltage tuning characteristic of liquid crystal mixtures is mainly described by a threshold voltage at which the liquid crystal starts to be affected by the voltage and the saturation voltage, above which an increase of the voltage does not cause major tuning in liquid crystal. These two characteristic parameters can change for different liquid crystal mixtures.

In one embodiment, as discussed above, a matrix drive is used to apply voltage to the patches in order to drive each cell separately from all the other cells without having a separate connection for each cell (direct drive). Because of the high density of elements, the matrix drive is an efficient way to address each cell individually.

In one embodiment, the control structure for the antenna system has 2 main components: the antenna array controller, which includes drive electronics, for the antenna system, is below the wave scattering structure (of surface scattering antenna elements such as described herein), while the matrix drive switching array is interspersed throughout the radiating RF array in such a way as to not interfere with the radiation. In one embodiment, the drive electronics for the antenna system comprise commercial off-the shelf LCD controls used in commercial television appliances that adjust the bias voltage for each scattering element by adjusting the amplitude or duty cycle of an AC bias signal to that element.

In one embodiment, the antenna array controller also contains a microprocessor executing the software. The control structure may also incorporate sensors (e.g., a GPS receiver, a three-axis compass, a 3-axis accelerometer, 3-axis gyro, 3-axis magnetometer, etc.) to provide location and orientation information to the processor. The location and orientation information may be provided to the processor by other systems in the earth station and/or may not be part of the antenna system.

More specifically, the antenna array controller controls which elements are turned off and those elements turned on and at which phase and amplitude level at the frequency of operation. The elements are selectively detuned for frequency operation by voltage application.

For transmission, a controller supplies an array of voltage signals to the RF patches to create a modulation, or control pattern. The control pattern causes the elements to be turned to different states. In one embodiment, multistate control is used in which various elements are turned on and off to varying levels, further approximating a sinusoidal control pattern, as opposed to a square wave (i.e., a sinusoid gray shade modulation pattern). In one embodiment, some elements radiate more strongly than others, rather than some elements radiate and some do not. Variable radiation is achieved by applying specific voltage levels, which adjusts the liquid crystal permittivity to varying amounts, thereby detuning elements variably and causing some elements to radiate more than others.

The generation of a focused beam by the metamaterial array of elements can be explained by the phenomenon of constructive and destructive interference. Individual electromagnetic waves sum up (constructive interference) if they have the same phase when they meet in free space and waves cancel each other (destructive interference) if they are in opposite phase when they meet in free space. If the slots in a slotted antenna are positioned so that each successive slot is positioned at a different distance from the excitation point of the guided wave, the scattered wave from that element will have a different phase than the scattered wave of the previous slot. If the slots are spaced one quarter of a guided wavelength apart, each slot will scatter a wave with a one fourth phase delay from the previous slot.

Using the array, the number of patterns of constructive and destructive interference that can be produced can be increased so that beams can be pointed theoretically in any direction plus or minus ninety degrees (90°) from the bore sight of the antenna array, using the principles of holography. Thus, by controlling which metamaterial unit cells are turned on or off (i.e., by changing the pattern of which cells are turned on and which cells are turned off), a different pattern of constructive and destructive interference can be produced, and the antenna can change the direction of the main beam. The time required to turn the unit cells on and off dictates the speed at which the beam can be switched from one location to another location.

In one embodiment, the antenna system produces one steerable beam for the uplink antenna and one steerable beam for the downlink antenna. In one embodiment, the antenna system uses metamaterial technology to receive beams and to decode signals from the satellite and to form transmit beams that are directed toward the satellite. In one embodiment, the antenna systems are analog systems, in contrast to antenna systems that employ digital signal processing to electrically form and steer beams (such as phased array antennas). In one embodiment, the antenna system is considered a “surface” antenna that is planar and relatively low profile, especially when compared to conventional satellite dish receivers.

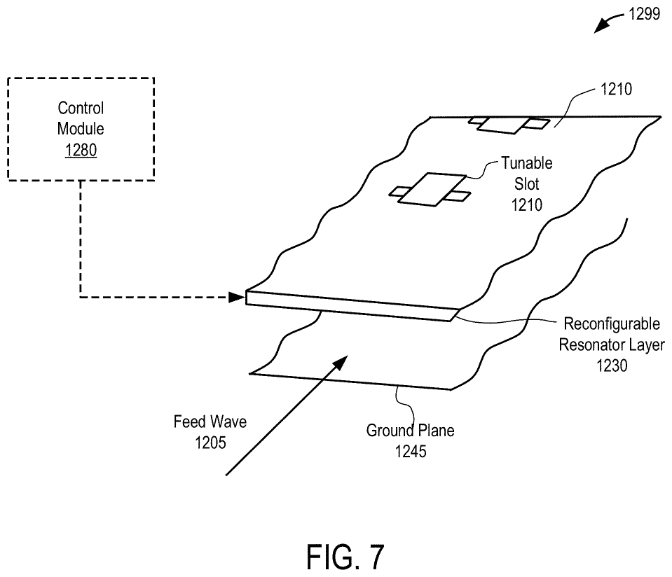

FIG. 7 illustrates a perspective view of one row of antenna elements that includes a ground plane and a reconfigurable resonator layer. Reconfigurable resonator layer 1230 includes an array of tunable slots 1210. The array of tunable slots 1210 can be configured to point the antenna in a desired direction. Each of the tunable slots can be tuned/adjusted by varying a voltage across the liquid crystal.

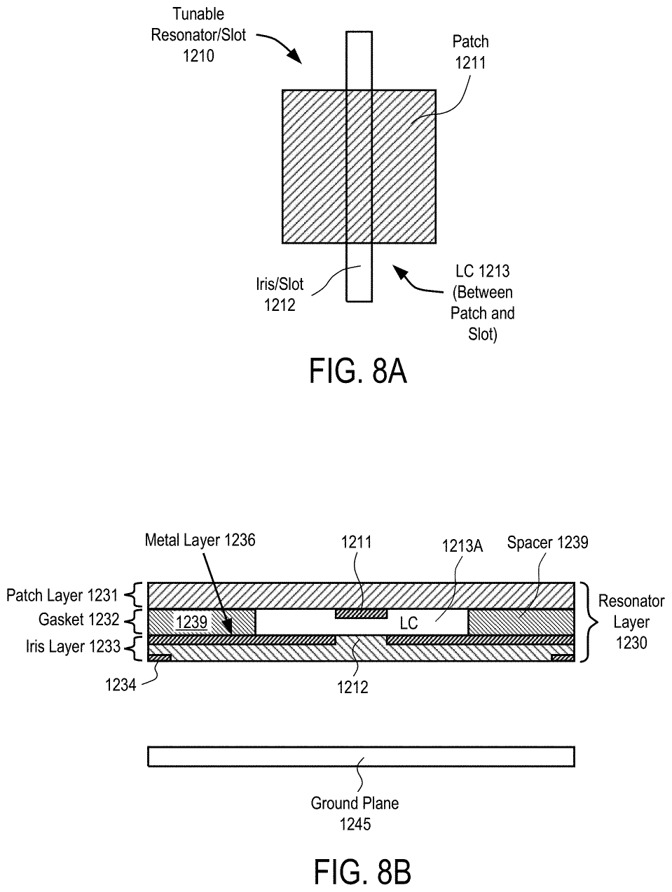

Control module, or controller, 1280 is coupled to reconfigurable resonator layer 1230 to modulate the array of tunable slots 1210 by varying the voltage across the liquid crystal in FIG. 8A. Control module 1280 may include a Field Programmable Gate Array (“FPGA”), a microprocessor, a controller, System-on-a-Chip (SoC), or other processing logic. In one embodiment, control module 1280 includes logic circuitry (e.g., multiplexer) to drive the array of tunable slots 1210. In one embodiment, control module 1280 receives data that includes specifications for a holographic diffraction pattern to be driven onto the array of tunable slots 1210. The holographic diffraction patterns may be generated in response to a spatial relationship between the antenna and a satellite so that the holographic diffraction pattern steers the downlink beams (and uplink beam if the antenna system performs transmit) in the appropriate direction for communication. Although not drawn in each figure, a control module similar to control module 1280 may drive each array of tunable slots described in the figures of the disclosure.

Radio Frequency (“RF”) holography is also possible using analogous techniques where a desired RF beam can be generated when an RF reference beam encounters an RF holographic diffraction pattern. In the case of satellite communications, the reference beam is in the form of a feed wave, such as feed wave 1205 (approximately 20 GHz in some embodiments). To transform a feed wave into a radiated beam (either for transmitting or receiving purposes), an interference pattern is calculated between the desired RF beam (the object beam) and the feed wave (the reference beam). The interference pattern is driven onto the array of tunable slots 1210 as a diffraction pattern so that the feed wave is “steered” into the desired RF beam (having the desired shape and direction). In other words, the feed wave encountering the holographic diffraction pattern “reconstructs” the object beam, which is formed according to design requirements of the communication system. The holographic diffraction pattern contains the excitation of each element and is calculated by w_{hologram}=wᵢₙ*wₒᵤₜ, with wᵢₙ as the wave equation in the waveguide and wₒᵤₜ the wave equation on the outgoing wave.

FIG. 8A illustrates one embodiment of a tunable resonator/slot 1210. Tunable slot 1210 includes an iris/slot 1212, a radiating patch 1211, and liquid crystal 1213 disposed between iris 1212 and patch 1211. In one embodiment, radiating patch 1211 is co-located with iris 1212.

FIG. 8B illustrates a cross section view of one embodiment of a physical antenna aperture. The antenna aperture includes ground plane 1245, and a metal layer 1236 within iris layer 1233, which is included in reconfigurable resonator layer 1230. In one embodiment, the antenna aperture of FIG. 8B includes a plurality of tunable resonator/slots 1210 of FIG. 8A. Iris/slot 1212 is defined by openings in metal layer 1236. A feed wave, such as feed wave 1205 of FIG. 8A, may have a microwave frequency compatible with satellite communication channels. The feed wave propagates between ground plane 1245 and resonator layer 1230.

Reconfigurable resonator layer 1230 also includes gasket layer 1232 and patch layer 1231. Gasket layer 1232 is disposed between patch layer 1231 and iris layer 1233. Note that in one embodiment, a spacer could replace gasket layer 1232. In one embodiment, iris layer 1233 is a printed circuit board (“PCB”) that includes a copper layer as metal layer 1236. In one embodiment, iris layer 1233 is glass. Iris layer 1233 may be other types of substrates.

Openings may be etched in the copper layer to form slots 1212. In one embodiment, iris layer 1233 is conductively coupled by a conductive bonding layer to another structure (e.g., a waveguide) in FIG. 8B. Note that in an embodiment the iris layer is not conductively coupled by a conductive bonding layer and is instead interfaced with a non-conducting bonding layer.

Patch layer 1231 may also be a PCB that includes metal as radiating patches 1211. In one embodiment, gasket layer 1232 includes spacers 1239 that provide a mechanical standoff to define the dimension between metal layer 1236 and patch 1211. In one embodiment, the spacers are 75 microns, but other sizes may be used (e.g., 3-200 mm). As mentioned above, in one embodiment, the antenna aperture of FIG. 8B includes multiple tunable resonator/slots, such as tunable resonator/slot 1210 includes patch 1211, liquid crystal 1213, and iris 1212 of FIG. 8A. The chamber for liquid crystal 1213 is defined by spacers 1239, iris layer 1233 and metal layer 1236. When the chamber is filled with liquid crystal, patch layer 1231 can be laminated onto spacers 1239 to seal liquid crystal within resonator layer 1230.

A voltage between patch layer 1231 and iris layer 1233 can be modulated to tune the liquid crystal in the gap between the patch and the slots (e.g., tunable resonator/slot 1210). Adjusting the voltage across liquid crystal 1213 varies the capacitance of a slot (e.g., tunable resonator/slot 1210). Accordingly, the reactance of a slot (e.g., tunable resonator/slot 1210) can be varied by changing the capacitance. Resonant frequency of slot 1210 also changes according to the equation

$$f = \frac{1}{2 π \sqrt{LC}}$$

where f is the resonant frequency of slot 1210 and L and C are the inductance and capacitance of slot 1210, respectively. The resonant frequency of slot 1210 affects the energy radiated from feed wave 1205 propagating through the waveguide. As an example, if feed wave 1205 is 20 GHz, the resonant frequency of a slot 1210 may be adjusted (by varying the capacitance) to 17 GHz so that the slot 1210 couples substantially no energy from feed wave 1205. Or, the resonant frequency of a slot 1210 may be adjusted to 20 GHz so that the slot 1210 couples energy from feed wave 1205 and radiates that energy into free space. Although the examples given are binary (fully radiating or not radiating at all), full gray scale control of the reactance, and therefore the resonant frequency of slot 1210 is possible with voltage variance over a multi-valued range. Hence, the energy radiated from each slot 1210 can be finely controlled so that detailed holographic diffraction patterns can be formed by the array of tunable slots.

In one embodiment, tunable slots in a row are spaced from each other by °/5. Other spacings may be used. In one embodiment, each tunable slot in a row is spaced from the closest tunable slot in an adjacent row by °/2, and, thus, commonly oriented tunable slots in different rows are spaced by λ/4, though other spacings are possible (e.g., λ/5, λ/6.3). In another embodiment, each tunable slot in a row is spaced from the closest tunable slot in an adjacent row by λ/3.

Embodiments use reconfigurable metamaterial technology, such as described in U.S. patent application Ser. No. 14/550,178, entitled “Dynamic Polarization and Coupling Control from a Steerable Cylindrically Fed Holographic Antenna”, filed Nov. 21, 2014 and U.S. patent application Ser. No. 14/610,502, entitled “Ridged Waveguide Feed Structures for Reconfigurable Antenna”, filed Jan. 30, 2015.

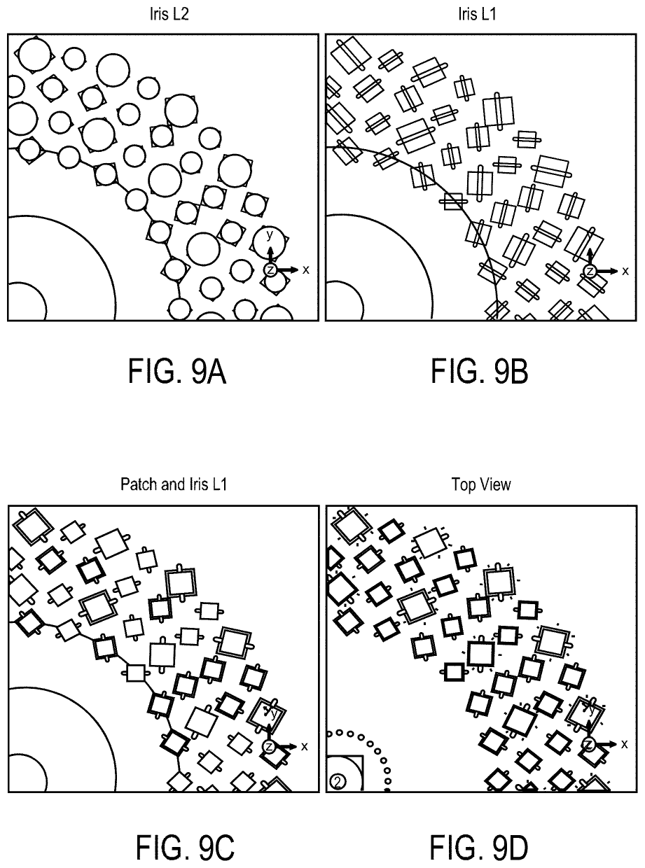

FIGS. 9A-D illustrate one embodiment of the different layers for creating the slotted array. The antenna array includes antenna elements that are positioned in rings, such as the example rings shown in FIG. 6. Note that in this example the antenna array has two different types of antenna elements that are used for two different types of frequency bands.

FIG. 9A illustrates a portion of the first iris board layer with locations corresponding to the slots. Referring to FIG. 9A, the circles are open areas/slots in the metallization in the bottom side of the iris substrate, and are for controlling the coupling of elements to the feed (the feed wave). Note that this layer is an optional layer and is not used in all designs. FIG. 9B illustrates a portion of the second iris board layer containing slots. FIG. 9C illustrates patches over a portion of the second iris board layer. FIG. 9D illustrates a top view of a portion of the slotted array.

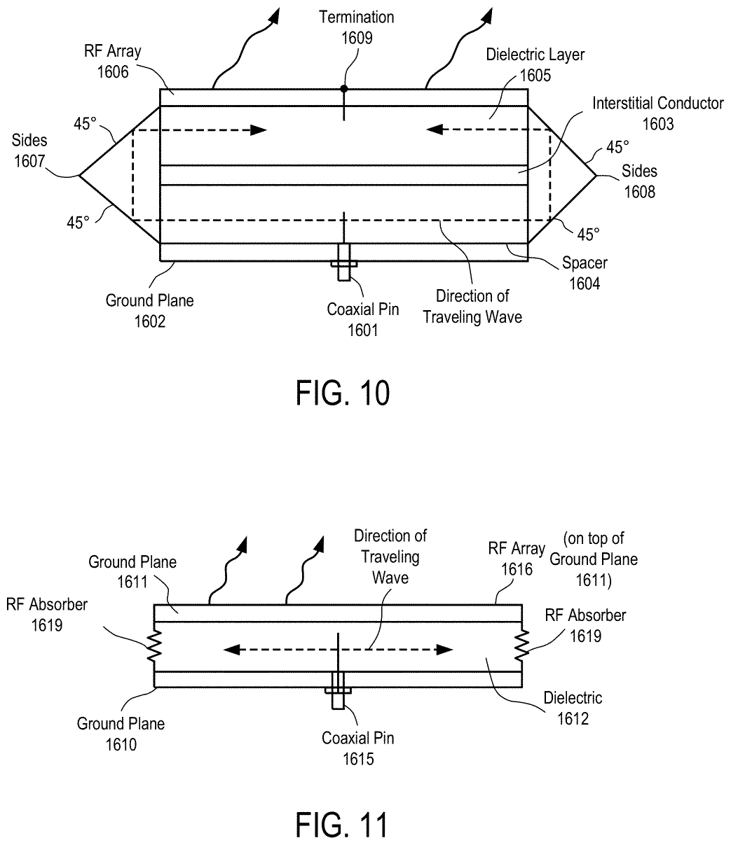

FIG. 10 illustrates a side view of one embodiment of a cylindrically fed antenna structure. The antenna produces an inwardly travelling wave using a double layer feed structure (i.e., two layers of a feed structure). In one embodiment, the antenna includes a circular outer shape, though this is not required. That is, non-circular inward travelling structures can be used. In one embodiment, the antenna structure in FIG. 10 includes a coaxial feed, such as, for example, described in U.S. Publication No. 2015/0236412, entitled “Dynamic Polarization and Coupling Control from a Steerable Cylindrically Fed Holographic Antenna”, filed on Nov. 21, 2014.

Referring to FIG. 10, a coaxial pin 1601 is used to excite the field on the lower level of the antenna. In one embodiment, coaxial pin 1601 is a 50Ω coax pin that is readily available. Coaxial pin 1601 is coupled (e.g., bolted) to the bottom of the antenna structure, which is conducting ground plane 1602.

Separate from conducting ground plane 1602 is interstitial conductor 1603, which is an internal conductor. In one embodiment, conducting ground plane 1602 and interstitial conductor 1603 are parallel to each other. In one embodiment, the distance between ground plane 1602 and interstitial conductor 1603 is 0.1-0.15″. In another embodiment, this distance may be A/2, where λ is the wavelength of the travelling wave at the frequency of operation.

Ground plane 1602 is separated from interstitial conductor 1603 via a spacer 1604. In one embodiment, spacer 1604 is a foam or air-like spacer. In one embodiment, spacer 1604 comprises a plastic spacer.

On top of interstitial conductor 1603 is dielectric layer 1605. In one embodiment, dielectric layer 1605 is plastic. The purpose of dielectric layer 1605 is to slow the travelling wave relative to free space velocity. In one embodiment, dielectric layer 1605 slows the travelling wave by 30% relative to free space. In one embodiment, the range of indices of refraction that are suitable for beam forming are 1.2-1.8, where free space has by definition an index of refraction equal to 1. Other dielectric spacer materials, such as, for example, plastic, may be used to achieve this effect. Note that materials other than plastic may be used as long as they achieve the desired wave slowing effect. Alternatively, a material with distributed structures may be used as dielectric 1605, such as periodic sub-wavelength metallic structures that can be machined or lithographically defined, for example.

An RF-array 1606 is on top of dielectric 1605. In one embodiment, the distance between interstitial conductor 1603 and RF-array 1606 is 0.1-0.15″. In another embodiment, this distance may be λ_{eff}/2, where λ_{eff} is the effective wavelength in the medium at the design frequency.

The antenna includes sides 1607 and 1608. Sides 1607 and 1608 are angled to cause a travelling wave feed from coax pin 1601 to be propagated from the area below interstitial conductor 1603 (the spacer layer) to the area above interstitial conductor 1603 (the dielectric layer) via reflection. In one embodiment, the angle of sides 1607 and 1608 are at 45° angles. In an alternative embodiment, sides 1607 and 1608 could be replaced with a continuous radius to achieve the reflection. While FIG. 10 shows angled sides that have angle of 45 degrees, other angles that accomplish signal transmission from lower level feed to upper level feed may be used. That is, given that the effective wavelength in the lower feed will generally be different than in the upper feed, some deviation from the ideal 45° angles could be used to aid transmission from the lower to the upper feed level. For example, in another embodiment, the 45° angles are replaced with a single step. The steps on one end of the antenna go around the dielectric layer, interstitial the conductor, and the spacer layer. The same two steps are at the other ends of these layers.

In operation, when a feed wave is fed in from coaxial pin 1601, the wave travels outward concentrically oriented from coaxial pin 1601 in the area between ground plane 1602 and interstitial conductor 1603. The concentrically outgoing waves are reflected by sides 1607 and 1608 and travel inwardly in the area between interstitial conductor 1603 and RF array 1606. The reflection from the edge of the circular perimeter causes the wave to remain in phase (i.e., it is an in-phase reflection). The travelling wave is slowed by dielectric layer 1605. At this point, the travelling wave starts interacting and exciting with elements in RF array 1606 to obtain the desired scattering.

To terminate the travelling wave, a termination 1609 is included in the antenna at the geometric center of the antenna. In one embodiment, termination 1609 comprises a pin termination (e.g., a 50Ω pin). In another embodiment, termination 1609 comprises an RF absorber that terminates unused energy to prevent reflections of that unused energy back through the feed structure of the antenna. These could be used at the top of RF array 1606.

FIG. 11 illustrates another embodiment of the antenna system with an outgoing wave. Referring to FIG. 11, two ground planes 1610 and 1611 are substantially parallel to each other with a dielectric layer 1612 (e.g., a plastic layer, etc.) in between ground planes. RF absorbers 1619 (e.g., resistors) couple the two ground planes 1610 and 1611 together. A coaxial pin 1615 (e.g., 50Ω) feeds the antenna. An RF array 1616 is on top of dielectric layer 1612 and ground plane 1611.

In operation, a feed wave is fed through coaxial pin 1615 and travels concentrically outward and interacts with the elements of RF array 1616.

The cylindrical feed in both the antennas of FIGS. 10 and 11 improves the service angle of the antenna. Instead of a service angle of plus or minus forty-five degrees azimuth (±45° Az) and plus or minus twenty-five degrees elevation (±25° El), in one embodiment, the antenna system has a service angle of seventy-five degrees (75°) from the bore sight in all directions. As with any beam forming antenna comprised of many individual radiators, the overall antenna gain is dependent on the gain of the constituent elements, which themselves are angle-dependent. When using common radiating elements, the overall antenna gain typically decreases as the beam is pointed further off bore sight. At 75 degrees off bore sight, significant gain degradation of about 6 dB is expected.

Embodiments of the antenna having a cylindrical feed solve one or more problems. These include dramatically simplifying the feed structure compared to antennas fed with a corporate divider network and therefore reducing total required antenna and antenna feed volume; decreasing sensitivity to manufacturing and control errors by maintaining high beam performance with coarser controls (extending all the way to simple binary control); giving a more advantageous side lobe pattern compared to rectilinear feeds because the cylindrically oriented feed waves result in spatially diverse side lobes in the far field; and allowing polarization to be dynamic, including allowing left-hand circular, right-hand circular, and linear polarizations, while not requiring a polarizer.

### Array of Wave Scattering Elements

RF array 1606 of FIG. 10 and RF array 1616 of FIG. 11 include a wave scattering subsystem that includes a group of patch antennas (i.e., scatterers) that act as radiators. This group of patch antennas comprises an array of scattering metamaterial elements.

In one embodiment, each scattering element in the antenna system is part of a unit cell that consists of a lower conductor, a dielectric substrate and an upper conductor that embeds a complementary electric inductive-capacitive resonator (“complementary electric LC” or “CELL”) that is etched in or deposited onto the upper conductor.

In one embodiment, a liquid crystal (LC) is injected in the gap around the scattering element. Liquid crystal is encapsulated in each unit cell and separates the lower conductor associated with a slot from an upper conductor associated with its patch. Liquid crystal has a permittivity that is a function of the orientation of the molecules comprising the liquid crystal, and the orientation of the molecules (and thus the permittivity) can be controlled by adjusting the bias voltage across the liquid crystal. Using this property, the liquid crystal acts as an on/off switch for the transmission of energy from the guided wave to the CELC. When switched on, the CELC emits an electromagnetic wave like an electrically small dipole antenna.

Controlling the thickness of the LC increases the beam switching speed. A fifty percent (50%) reduction in the gap between the lower and the upper conductor (the thickness of the liquid crystal) results in a fourfold increase in speed. In another embodiment, the thickness of the liquid crystal results in a beam switching speed of approximately fourteen milliseconds (14 ms). In one embodiment, the LC is doped in a manner well-known in the art to improve responsiveness so that a seven millisecond (7 ms) requirement can be met.

The CELC element is responsive to a magnetic field that is applied parallel to the plane of the CELC element and perpendicular to the CELC gap complement. When a voltage is applied to the liquid crystal in the metamaterial scattering unit cell, the magnetic field component of the guided wave induces a magnetic excitation of the CELC, which, in turn, produces an electromagnetic wave in the same frequency as the guided wave.

The phase of the electromagnetic wave generated by a single CELC can be selected by the position of the CELC on the vector of the guided wave. Each cell generates a wave in phase with the guided wave parallel to the CELC. Because the CELCs are smaller than the wave length, the output wave has the same phase as the phase of the guided wave as it passes beneath the CELC.

In one embodiment, the cylindrical feed geometry of this antenna system allows the CELC elements to be positioned at forty-five degree (45°) angles to the vector of the wave in the wave feed. This position of the elements enables control of the polarization of the free space wave generated from or received by the elements. In one embodiment, the CELCs are arranged with an inter-element spacing that is less than a free-space wavelength of the operating frequency of the antenna. For example, if there are four scattering elements per wavelength, the elements in the 30 GHz transmit antenna will be approximately 2.5 mm (i.e., ¼th the 10 mm free-space wavelength of 30 GHz).

In one embodiment, the CELCs are implemented with patch antennas that include a patch co-located over a slot with liquid crystal between the two. In this respect, the metamaterial antenna acts like a slotted (scattering) wave guide. With a slotted wave guide, the phase of the output wave depends on the location of the slot in relation to the guided wave.

### Cell Placement

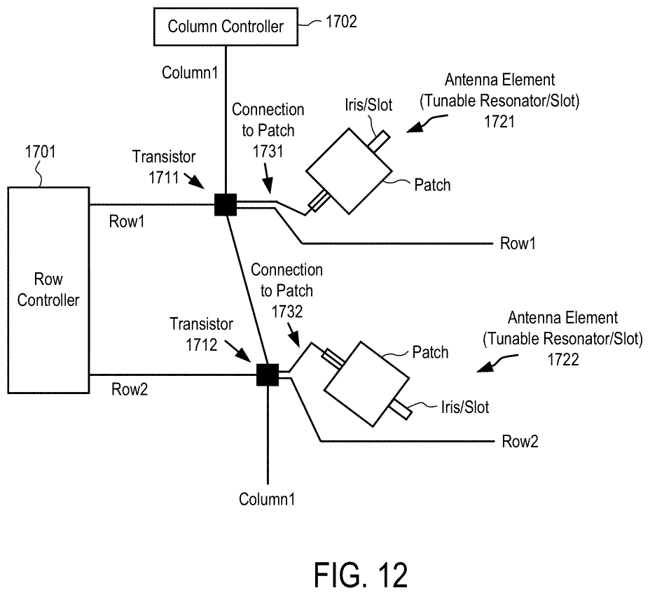

In one embodiment, the antenna elements are placed on the cylindrical feed antenna aperture in a way that allows for a systematic matrix drive circuit. The placement of the cells includes placement of the transistors for the matrix drive. FIG. 12 illustrates one embodiment of the placement of matrix drive circuitry with respect to antenna elements. Referring to FIG. 12, row controller 1701 is coupled to transistors 1711 and 1712, via row select signals Row1 and Row2, respectively, and column controller 1702 is coupled to transistors 1711 and 1712 via column select signal Column1. Transistor 1711 is also coupled to antenna element 1721 via connection to patch 1731, while transistor 1712 is coupled to antenna element 1722 via connection to patch 1732.

In an initial approach to realize matrix drive circuitry on the cylindrical feed antenna with unit cells placed in a non-regular grid, two steps are performed. In the first step, the cells are placed on concentric rings and each of the cells is connected to a transistor that is placed beside the cell and acts as a switch to drive each cell separately. In the second step, the matrix drive circuitry is built in order to connect every transistor with a unique address as the matrix drive approach requires. Because the matrix drive circuit is built by row and column traces (similar to LCDs) but the cells are placed on rings, there is no systematic way to assign a unique address to each transistor. This mapping problem results in very complex circuitry to cover all the transistors and leads to a significant increase in the number of physical traces to accomplish the routing. Because of the high density of cells, those traces disturb the RF performance of the antenna due to coupling effect. Also, due to the complexity of traces and high packing density, the routing of the traces cannot be accomplished by commercially available layout tools.

In one embodiment, the matrix drive circuitry is predefined before the cells and transistors are placed. This ensures a minimum number of traces that are necessary to drive all the cells, each with a unique address. This strategy reduces the complexity of the drive circuitry and simplifies the routing, which subsequently improves the RF performance of the antenna.

More specifically, in one approach, in the first step, the cells are placed on a regular rectangular grid composed of rows and columns that describe the unique address of each cell. In the second step, the cells are grouped and transformed to concentric circles while maintaining their address and connection to the rows and columns as defined in the first step. A goal of this transformation is not only to put the cells on rings but also to keep the distance between cells and the distance between rings constant over the entire aperture. In order to accomplish this goal, there are several ways to group the cells.

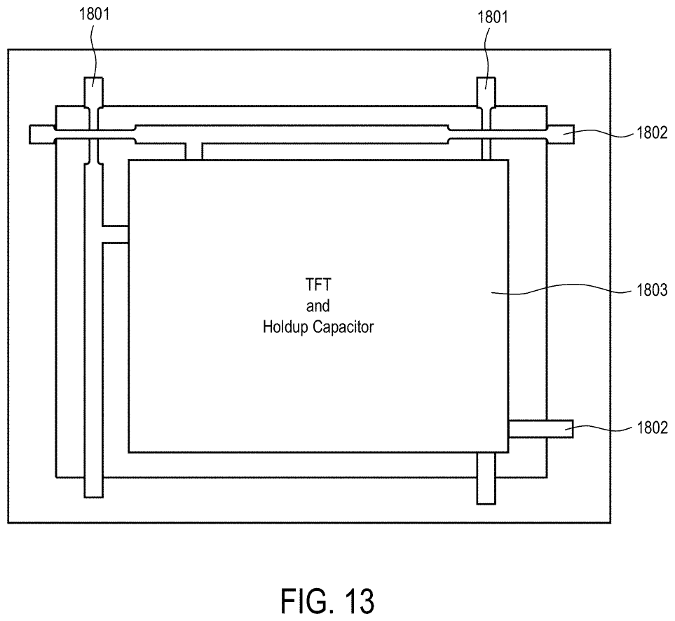

In one embodiment, a TFT package is used to enable placement and unique addressing in the matrix drive. FIG. 13 illustrates one embodiment of a TFT package. Referring to FIG. 13, a TFT and a hold capacitor 1803 is shown with input and output ports. There are two input ports connected to traces 1801 and two output ports connected to traces 1802 to connect the TFTs together using the rows and columns. In one embodiment, the row and column traces cross in 90° angles to reduce, and potentially minimize, the coupling between the row and column traces. In one embodiment, the row and column traces are on different layers.

### An Example of a Full Duplex Communication System

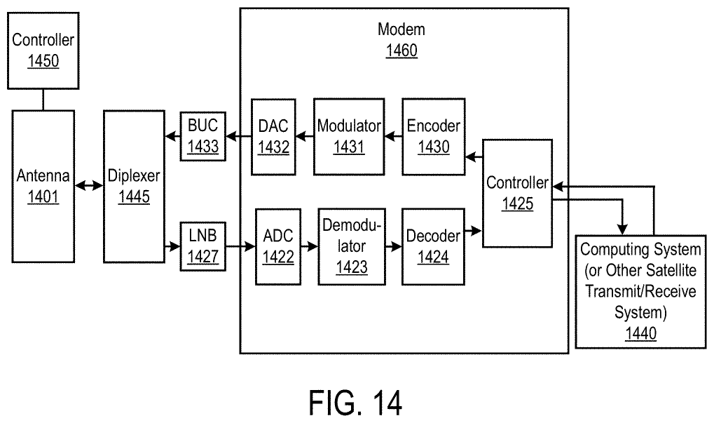

In another embodiment, the combined antenna apertures are used in a full duplex communication system. FIG. 14 is a block diagram of an embodiment of a communication system having simultaneous transmit and receive paths. While only one transmit path and one receive path are shown, the communication system may include more than one transmit path and/or more than one receive path.

Referring to FIG. 14, antenna 1401 includes two spatially interleaved antenna arrays operable independently to transmit and receive simultaneously at different frequencies as described above. In one embodiment, antenna 1401 is coupled to diplexer 1445. The coupling may be by one or more feeding networks. In one embodiment, in the case of a radial feed antenna, diplexer 1445 combines the two signals and the connection between antenna 1401 and diplexer 1445 is a single broad-band feeding network that can carry both frequencies.

Diplexer 1445 is coupled to a low noise block down converter (LNBs) 1427, which performs a noise filtering function and a down conversion and amplification function in a manner well-known in the art. In one embodiment, LNB 1427 is in an out-door unit (ODU). In another embodiment, LNB 1427 is integrated into the antenna apparatus. LNB 1427 is coupled to a modem 1460, which is coupled to computing system 1440 (e.g., a computer system, modem, etc.).

Modem 1460 includes an analog-to-digital converter (ADC) 1422, which is coupled to LNB 1427, to convert the received signal output from diplexer 1445 into digital format. Once converted to digital format, the signal is demodulated by demodulator 1423 and decoded by decoder 1424 to obtain the encoded data on the received wave. The decoded data is then sent to controller 1425, which sends it to computing system 1440.

Modem 1460 also includes an encoder 1430 that encodes data to be transmitted from computing system 1440. The encoded data is modulated by modulator 1431 and then converted to analog by digital-to-analog converter (DAC) 1432. The analog signal is then filtered by a BUC (up-convert and high pass amplifier) 1433 and provided to one port of diplexer 1445. In one embodiment, BUC 1433 is in an out-door unit (ODU).

Diplexer 1445 operating in a manner well-known in the art provides the transmit signal to antenna 1401 for transmission.

Controller 1450 controls antenna 1401, including the two arrays of antenna elements on the single combined physical aperture.

The communication system would be modified to include the combiner/arbiter described above. In such a case, the combiner/arbiter after the modem but before the BUC and LNB.

Note that the full duplex communication system shown in FIG. 14 has a number of applications, including but not limited to, internet communication, vehicle communication (including software updating), etc.

There is a number of example embodiments described herein.

Example 1 is a method comprising receiving external information related to a route being taken by a vehicle containing an antenna for use in wireless communication; and proactively switching from a first communication connection to a second communication connection before reaching a location on the route that the vehicle is expected to pass at a future time and at which the first communication connection is expected to be unavailable.

Example 2 is the method of example 1 that may optionally include that the external information includes one or more of traffic conditions along the route, weather conditions along the route, and road outage conditions along the route.

Example 3 is the method of example 1 that may optionally include determining the first communication connection with the antenna is not expected to be available at the location on the route at the future time, including determining when the vehicle is to be expected at the location.

Example 4 is the method of example 3 that may optionally include that determining the first communication connection with the antenna is not expected to be available at the location on the route is based on one or more of outage information collected by the vehicle regarding at least one other time when the vehicle was at the location, outage information collected by one or more other vehicles regarding at least one other time when the one or more other vehicles were at the location, and other outage information obtained regarding the location.

Example 5 is the method of example 3 that may optionally include that determining when the vehicle is to be expected at the location is based on one or more of speed of the vehicle, direction of travel, and a portion of the external information.

Example 6 is the method of example 1 that may optionally include that the first connection is a satellite connection and the second connection is a terrestrial network connection.

Example 7 is the method of example 1 that may optionally include that the second connection is set up prior to switching from the first connection.

Example 8 is the method of example 1 that may optionally include that proactively switching from the first communication connection to the second communication connection includes performing a handoff of a session from the first communication connection to the second communication connection.

Example 9 is the method of example 1 that may optionally include that proactively switching from the first communication connection to the second communication connection comprises determining a plurality of connections that are available for switching, the plurality of connections including the second connection; and selecting the second connection from the plurality of connections.

Example 10 is the method of example 9 that may optionally include that selecting the second connection from the plurality of connections is based on one or more of a user's selection, connection cost, connection reliability, and data transfer speed.

Example 11 is the method of example 1 that may optionally include capturing, by the vehicle, vehicle outage information, direction of travel, information about current location and time of day, and wherein proactively switching from the first communication connection to the second communication connection is based on the captured information.

Example 12 is the method of example 1 that may optionally include displaying a user interface to provide one or more notifications to an occupant of the vehicle.

Example 13 is the method of example 12 that may optionally include that the one or more notifications comprise: information related to availability of real-time communication along the route; an indication of an amount of time the availability of the real-time communication remains open; information depicting one or more alternative vehicle routes that may be taken with real-time communication availability; information specifying one or more areas along the route to stop the vehicle with continued communication connectivity; information specifying an area to have access to satellite communication; and information specifying an amount of time the vehicle is able to maintain communication connectivity or until such communication connectivity is obtainable.

Example 14 is the method of example 1 that may optionally include comprising wirelessly transmitting, by the vehicle to a connectivity system, one or more of the following: a notification to a connectivity system to hold communications until a communication window occurs; a prioritization as to messages that are to be sent to the vehicle; and a command to switch communications to an alternative communication connection.

Example 15 is a system to control data routing comprising: a satellite antenna of a vehicle; a receiver to receive external information related to a route being taken by the vehicle; a subsystem to analyze data including the external information to predict when a first communication connection is expected to be unavailable at a location on the route that the vehicle is expected to pass at a future time; and a controller coupled to the subsystem and the satellite to proactively switch communication for the vehicle from the first communication connection to a second communication connection before reaching the location on the route.

Example 16 is the system of example 15 that may optionally include that the subsystem is operable to wherein the first connection is a satellite connection and the second connection is a terrestrial network connection, and wherein the controller switches based on information from the subsystem.

Example 17 is the system of example 15 that may optionally include that the external information includes one or more of traffic conditions along the route, weather conditions along the route, and road outage conditions along the route.

Example 18 is the system of example 15 that may optionally include that the subsystem is operable to determine communication using with the satellite antenna is not expected to be available at the location on the route at the future time and also is operable to determine when the vehicle is to be expected at the location.

Example 19 is the system of example 18 that may optionally include that the subsystem is operable to determine communication using with the satellite antenna is not expected to be available is not expected to be available at the location on the route based on one or more of outage information collected by the vehicle regarding at least one other time when the vehicle was at the location, outage information collected by one or more other vehicles regarding at least one other time when the one or more other vehicles were at the location, and other outage information obtained regarding the location.

Example 20 is the system of example 18 that may optionally include that the subsystem is operable to determine when the vehicle is to be expected at the location based on one or more of speed of the vehicle and a portion of the external information.

Example 21 is the system of example 15 that may optionally include that the controller is operable to perform a handoff of a session from the first communication connection to the second communication connection when proactively switching from the first communication connection to the second communication connection.

Example 22 is the system of example 15 that may optionally include that the controller is operable to select the second connection from the plurality of connections based on one or more of a user's selection, connection cost, connection reliability, and data transfer speed.

Example 23 is the system of example 15 that may optionally include a display coupled to the controller to display a user interface to provide one or more notifications to an occupant of the vehicle.

Example 24 is the system of example 23 that may optionally include that the one or more notifications comprise: information related to availability of real-time communication along the route; an indication of an amount of time the availability of the real-time communication remains open; information depicting one or more alternative vehicle routes that may be taken with real-time communication availability; information specifying one or more areas along the route to stop the vehicle with continued communication connectivity; information specifying an area to have access to satellite communication; and information specifying an amount of time the vehicle is able to maintain communication connectivity or until such communication connectivity is obtainable.

Example 25 is a non-transitory computer-readable storage medium having stored thereon data representing sequences of instructions that, when executed by a system, cause the system to perform operations comprising: receiving external information related to a route being taken by a vehicle containing an antenna for use in wireless communication; and proactively switching from a first communication connection to a second communication connection before reaching a location on the route that the vehicle is expected to pass at a future time and at which the first communication connection is expected to be unavailable.

Example 26 is the medium of example 25 that may optionally include that the external information includes one or more of traffic conditions along the route, weather conditions along the route, and road outage conditions along the route.

Example 27 is the medium of example 25 that may optionally include that the method further comprising determining the first communication connection with the antenna is not expected to be available at the location on the route at the future time, including determining when the vehicle is to be expected at the location.

Example 28 is the medium of example 27 that may optionally include that determining the first communication connection with the antenna is not expected to be available at the location on the route is based on one or more of outage information collected by the vehicle regarding at least one other time when the vehicle was at the location, outage information collected by one or more other vehicles regarding at least one other time when the one or more other vehicles were at the location, and other outage information obtained regarding the location.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; etc.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as essential to the invention.

We claim:

1. A method comprising:
receiving external information related to a route being taken by a vehicle containing an antenna for use in wireless communication; and
proactively switching from a first communication connection to a second communication connection before reaching a location on the route that the vehicle is expected to pass at a future time and at which the first communication connection is expected to be unavailable.

2. The method defined in claim 1 wherein the external information includes one or more of traffic conditions along the route, weather conditions along the route, and road outage conditions along the route.

3. The method defined in claim 1 further comprising determining the first communication connection with the antenna is not expected to be available at the location on the route at the future time, including determining when the vehicle is to be expected at the location.

4. The method defined in claim 3 wherein determining the first communication connection with the antenna is not expected to be available at the location on the route is based on one or more of outage information collected by the vehicle regarding at least one other time when the vehicle was at the location, outage information collected by one or more other vehicles regarding at least one other time when the one or more other vehicles were at the location, and other outage information obtained regarding the location.

5. The method defined in claim 3 wherein determining when the vehicle is to be expected at the location is based on one or more of speed of the vehicle, direction of travel, and a portion of the external information.

6. The method defined in claim 1 wherein the first connection is a satellite connection and the second connection is a terrestrial network connection.

7. The method defined in claim 1 wherein the second connection is set up prior to switching from the first connection.

8. The method defined in claim 1 wherein proactively switching from the first communication connection to the second communication connection includes performing a handoff of a session from the first communication connection to the second communication connection.

9. The method defined in claim 1 wherein proactively switching from the first communication connection to the second communication connection comprises
determining a plurality of connections that are available for switching, the plurality of connections including the second connection; and
selecting the second connection from the plurality of connections.

10. The method defined in claim 9 wherein selecting the second connection from the plurality of connections is based on one or more of a user's selection, connection cost, connection reliability, and data transfer speed.

11. The method defined in claim 1 further comprising capturing, by the vehicle, vehicle outage information, direction of travel, information about current location and time of day, and wherein proactively switching from the first communication connection to the second communication connection is based on the captured information.

12. The method defined in claim 1 further comprising displaying a user interface to provide one or more notifications to an occupant of the vehicle.

13. The method defined in claim 12 wherein the one or more notifications comprise:
information related to availability of real-time communication along the route;
an indication of an amount of time the availability of the real-time communication remains open;
information depicting one or more alternative vehicle routes that may be taken with real-time communication availability;
information specifying one or more areas along the route to stop the vehicle with continued communication connectivity;
information specifying an area to have access to satellite communication; and
information specifying an amount of time the vehicle is able to maintain communication connectivity or until such communication connectivity is obtainable.

14. The method defined in claim 1 further comprising wirelessly transmitting, by the vehicle to a connectivity system, one or more of the following:
a notification to a connectivity system to hold communications until a communication window occurs;
a prioritization as to messages that are to be sent to the vehicle; and
a command to switch communications to an alternative communication connection.

15. A system to control data routing, the system comprising:
a satellite antenna of a vehicle;
a receiver to receive external information related to a route being taken by the vehicle;
a subsystem to analyze data including the external information to predict when a first communication connection is expected to be unavailable at a location on the route that the vehicle is expected to pass at a future time; and
a controller coupled to the subsystem and the satellite to proactively switch communication for the vehicle from the first communication connection to a second communication connection before reaching the location on the route.

16. The system defined in claim 15 wherein the subsystem is operable to wherein the first connection is a satellite connection and the second connection is a terrestrial network connection, and wherein the controller switches based on information from the subsystem.

17. The system defined in claim 15 wherein the external information includes one or more of traffic conditions along the route, weather conditions along the route, and road outage conditions along the route.

18. The system defined in claim 15 wherein the subsystem is operable to determine communication using with the satellite antenna is not expected to be available at the location on the route at the future time and also is operable to determine when the vehicle is to be expected at the location.

19. The system defined in claim 18 wherein the subsystem is operable to determine communication using with the satellite antenna is not expected to be available is not expected to be available at the location on the route based on one or more of outage information collected by the vehicle regarding at least one other time when the vehicle was at the location, outage information collected by one or more other vehicles regarding at least one other time when the one or more other vehicles were at the location, and other outage information obtained regarding the location.

20. The system defined in claim 18 wherein the subsystem is operable to determine when the vehicle is to be expected at the location based on one or more of speed of the vehicle and a portion of the external information.

21. The system defined in claim 15 wherein the controller is operable to perform a handoff of a session from the first communication connection to the second communication connection when proactively switching from the first communication connection to the second communication connection.

22. The system defined in claim 15 wherein the controller is operable to select the second connection from the plurality of connections based on one or more of a user's selection, connection cost, connection reliability, and data transfer speed.

23. The system defined in claim 15 further comprising a display coupled to the controller to display a user interface to provide one or more notifications to an occupant of the vehicle.

24. The system defined in claim 23 wherein the one or more notifications comprise:
information related to availability of real-time communication along the route;
an indication of an amount of time the availability of the real-time communication remains open;
information depicting one or more alternative vehicle routes that may be taken with real-time communication availability;
information specifying one or more areas along the route to stop the vehicle with continued communication connectivity;
information specifying an area to have access to satellite communication; and
information specifying an amount of time the vehicle is able to maintain communication connectivity or until such communication connectivity is obtainable.

25. A non-transitory computer-readable storage medium having stored thereon data representing sequences of instructions that, when executed by a system, cause the system to perform operations comprising:
receiving external information related to a route being taken by a vehicle containing an antenna for use in wireless communication; and
proactively switching from a first communication connection to a second communication connection before reaching a location on the route that the vehicle is expected to pass at a future time and at which the first communication connection is expected to be unavailable.

26. The medium defined in claim 25 wherein the external information includes one or more of traffic conditions along the route, weather conditions along the route, and road outage conditions along the route.

27. The medium defined in claim 25 wherein the method further comprises determining the first communication connection with the antenna is not expected to be available at the location on the route at the future time, including determining when the vehicle is to be expected at the location.

28. The medium defined in claim 27 wherein determining the first communication connection with the antenna is not expected to be available at the location on the route is based on one or more of outage information collected by the vehicle regarding at least one other time when the vehicle was at the location, outage information collected by one or more other vehicles regarding at least one other time when the one or more other vehicles were at the location, and other outage information obtained regarding the location.
